(19) United States
(12) Patent Application Publication
(10) Pub. No.: US 2026/0295538 A1
(43) Pub. Date: Oct. 1, 2026

(54) MODULAR MULTI-FILTER SYSTEMS AND METHODS OF USE

(71) Applicant: Pentair Water Pool and Spa, Inc., Golden Valley, MN (US)

(72) Inventors: Azur Dzindo, Raleigh, NC (US); Thomas Johnson Ray Safon, Holly Springs, NC (US); Caleb Ray, Apex, NC (US); Anas Yousef Alhajeh, Clayton, NC (US); Alexander Smith, Fuquay-Varina, NC (US); Donnie Fore, Sanford, NC (US); Eric Pinnell, Holly Springs, NC (US)

(21) Appl. No.: 19/630,128

(22) Filed: Mar. 26, 2026

Related U.S. Application Data
(60) Provisional application No. 63/778,546, filed on Mar. 27, 2025.

(51) Int. Cl. B01D 65/02; B01D 61/02; B01D 69/08; C02F 1/00; C02F 1/44; C02F 103/42

(52) U.S. Cl. CPC B01D 65/02; B01D 61/025; B01D 69/08; C02F 1/001; C02F 1/441; B01D 2321/04; B01D 2321/162; B01D 2321/164; C02F 2103/42; C02F 2201/005; C02F 2201/006; C02F 2201/007; C02F 2303/16

(57) ABSTRACT

A multi-filter modular pack assembly for filtering a fluid from an aquatic application is provided. The multi-filter modular pack assembly includes a vessel including a housing, a plurality of filtration modules contained within the housing designed to filter the fluid from the aquatic application and produce a filtered fluid, an inlet port designed to direct the fluid from the aquatic application into the vessel, and an outlet port designed to direct the filtered fluid out of the vessel to the aquatic application, and one or more valves designed to control a flow of fluid. The one or more valves are in fluid communication with at least one of the inlet port, the outlet port, or the plurality of filtration modules.

### CROSS-REFERENCE TO RELATED APPLICATIONS

This application claims priority to U.S. Provisional Patent App. No. 63/778,546, titled “MODULAR PACK FILTER” and filed on Mar. 27, 2025, the entirety of which is incorporated herein by reference.

### TECHNICAL FIELD

This disclosure generally relates to filters. More particularly, the disclosure relates to a modular pack filter for an aquatic application.

### BACKGROUND

Filtration systems are an important aspect of maintaining water clarity and quality in aquatic systems. Environmental sources may introduce contaminants containing bacteria or pathogens into bodies of water. Swimmers and bathers may introduce other contaminants or debris, such as sweat, bodily oil or secretions, suntan lotion, urine, and other substances. In addition to contributing to high turbidity, contaminants may react with disinfectant chemicals to produce chloramines and other disinfection by-products, contributing to adverse health effects for bathers. Thus, in pool and spa systems, the water is typically passed through a filtration system to clean the water. Filtration systems are used to remove pollutants and contaminants to reduce turbidity and promote visual clarity of the water. Filtration systems are one mechanism that is used to help ensure healthy conditions in swimming pools, hot tubs, spas, plunge pools, and other recreational water venues or aquatic applications.

Traditional pool and spa filtration technologies include diatomaceous earth filters, pressure-fed sand filters, gravity sand filters, and cartridge filters. However, these filtration technologies have inherent shortcomings, including the inability to capture small, suspended solids, bacteria, and viruses without the use of filter aids or secondary sanitization devices. Conversely, high-efficiency filter media technology capable of capturing submicron particles and microorganisms may not be able to process larger suspended solids without becoming clogged. Thus, high-efficiency filter media, such as Reverse Osmosis (“RO”), hollow fiber membrane, or silicon carbide (“SiC”) ceramic technology, is traditionally employed through the use of one or more external (e.g., outside of the filter housing) pre-filter(s) to capture larger particles. However, removing particles of varying sizes may require multiple and/or separate filters that take up space on a pool pad, require individual piping and valving systems, and separate maintenance and cleaning.

Further, traditional filter systems may be cleaned through backwash operations, where the flow of water is reversed through the system to loosen and remove trapped particulates. However, backwashing may not remove all the contaminants collected by the filter, especially contaminants like organics, viruses, and bacteria. Moreover, in multi-filter systems, each individual filter may not foul at the same rate. Thus, when a backwash or other cleaning procedure is performed, the backwash fluid or cleaning fluid will likely flow through the least fouled filters. Accordingly, the more fouled filters will not be cleaned as effectively as the less fouled filters.

Therefore, there is a need in the art for a multi-filter filtration system enclosed within a single vessel that may effectively filter out both large and small contaminants without clogging the filtration system. Additionally, there is a need for a filtration system that includes systems and methods for effectively cleaning the multi-filter system to remove particulates and debris of various sizes.

### SUMMARY

A modular pack filter assembly for an aquatic application is disclosed. In a first instance, a multi-filter modular pack assembly for filtering a fluid from an aquatic application is provided. The multi-filter modular pack assembly includes a vessel including a housing, a plurality of filtration modules contained within the housing designed to filter the fluid from the aquatic application and produce a filtered fluid, an inlet port designed to direct the fluid from the aquatic application into the vessel, and an outlet port designed to direct the filtered fluid out of the vessel to the aquatic application, and one or more valves designed to control a flow of fluid. The one or more valves are in fluid communication with at least one of the inlet port, the outlet port, or the plurality of filtration modules.

In some instances, each filtration module of the plurality of filtration modules is independently selected from the group consisting of a diatomaceous earth filter, a pressure-fed sand filter, a gravity sand filter, a cartridge filter, a reverse osmosis filter, a hollow fiber membrane filter, and a silicon carbide filter.

In other instances, the plurality of filtration modules includes four filtration modules.

In yet further instances, the one or more valves include at least one isolation valve that is disposed within the vessel and is in fluid communication with the plurality of filtration modules. The at least one isolation valve is designed to control whether fluid is provided to a filtration module of the one or more of the plurality of filtration modules.

In some instances, the plurality of filtration modules are configured to process fluid in parallel.

In other instances, the multi-filter modular pack assembly further includes a fluid distribution system including a manifold designed to secure the plurality of filtration modules in a vertical configuration. The fluid distribution system includes a first manifold including a plurality of filtration module inlets designed to direct the fluid from the aquatic application into the plurality of filtration modules and a second manifold including a plurality of filtration module outlets designed to direct the filtered fluid from the plurality of filtration modules to the outlet port of the vessel.

In yet further instances, a valve of the one or more valves is provided as a three-way valve. The valve is placed in fluid communication with a filtration module of the plurality of filtration modules, the inlet port, and the outlet port.

In some instances, a valve of the one or more valves is provided as a multi-port valve, and the valve is placed in fluid communication with at least one filtration module of the plurality of filtration modules, the inlet port, and the outlet port.

In another aspect, a multi-filter modular pack assembly for filtering fluid from an aquatic application is provided. The multi-filter modular pack assembly includes a vessel including a plurality of filtration modules, an inlet conduit designed to direct an untreated fluid or a pre-filtered fluid from the aquatic application to the plurality of filtration modules, an outlet conduit designed to direct a filtered fluid from the multi-filter modular pack assembly to the aquatic application, a chemical cleaning system including a chemical cleaning tank designed to retain a chemical cleaning agent, and a controller designed to determine whether one or more of the plurality of filtration modules is fouled based on a determined permeability value and initiate a cleaning procedure when the determined permeability value is below a permeability threshold value. The chemical cleaning system is in fluid communication with the vessel.

In some instances, the chemical cleaning agent is selected from the group consisting of chlorine, bromine, calcium hypochlorite, trichloroisocyanuric acid, dichloro-s-triazinetrione, and combinations thereof.

In other instances, the cleaning procedure includes a backwash procedure. The multi-filter modular pack assembly is imparted with a first permeability before the backwash procedure, the backwash procedure imparts the multi-filter modular pack assembly with a second permeability, and the second permeability is greater than the first permeability.

In yet further instances, the cleaning procedure includes a chemical cleaning procedure, where the chemical cleaning procedure includes introducing the chemical cleaning agent to one or more of the plurality of filtration modules.

In some instances, the chemical cleaning system includes a chemical feed line in fluid communication with the inlet conduit.

In other instances, the chemical cleaning system includes a chemical feed line in fluid communication with a dosing port designed to deliver the chemical cleaning agent to the plurality of filtration modules.

In yet further instances, the determined permeability value is associated with a measured permeability for one or more of the plurality of filtration modules.

In some instances, the plurality of filtration modules include an air bleed designed to release a volume of air trapped in the plurality of filtration modules.

In yet another aspect, a method for cleaning a multi-filter modular pack assembly is provided. The method includes receiving an untreated or pre-filtered fluid from an aquatic application into a multi-filter modular pack assembly, directing the untreated or pre-filtered fluid into one or more of a plurality of filtration modules, determining a pressure differential between an inlet of the multi-filter modular pack assembly and an outlet of the multi-filter modular pack assembly, determining whether the pressure differential exceeds a predetermined pressure differential threshold value, and initiating a cleaning procedure when the pressure differential exceeds a predetermined pressure differential threshold value.

In some instances, the method further includes determining a permeability of the multi-filter modular pack assembly, comparing the permeability of the multi-filter modular pack assembly to a predetermined permeability value, and determining if the permeability of the multi-filter modular pack assembly exceeds the predetermined permeability value.

In other instances, the method further includes setting a start time for the cleaning procedure and waiting a predetermined time period.

In yet further instances, the method further includes determining a measured period of time between a first cleaning procedure and a second cleaning procedure before the second cleaning procedure has been initiated, determining whether the measured period of time exceeds a predetermined threshold time period, and preventing initiation of the second cleaning procedure until the measured period of time exceeds the predetermined threshold time period.

### DESCRIPTION OF THE DRAWINGS

FIG. 1 is a schematic diagram depicting an aquatic system provided in the form of a swimming pool and one or more components associated with a pool pad;

FIG. 2 is a front isometric view of a multi-filter module filter assembly according to an instance;

FIG. 3 is a side elevational view of the multi-filter module filter assembly of FIG. 2, with some portions of the multi-filter module filter assembly removed for clarity;

FIG. 4 is a front elevational view of the multi-filter module filter assembly of FIG. 2, with an outer housing of the multi-filter module filter assembly rendered with dashed lines, various components within the outer housing shown, and some portions of the multi-filter module filter assembly removed for clarity;

FIG. 5A is a schematic representation of a cross-sectional side view of a manifold and filtration module of the multi-filter module filter assembly of FIG. 2, with some portions removed for clarity;

FIG. 5B is an additional, enlarged, partial cross-sectional side view of a manifold and filtration module of the multi-filter module filter assembly of FIG. 2 with some portions removed for clarity;

FIG. 6A is a top plan view of a first portion of a manifold of the multi-filter module filter assembly of FIG. 2;

FIG. 6B is a side elevational view of a second portion of a manifold of the multi-filter module filter assembly of FIG. 2;

FIG. 7 is a schematic representation of a three-way valve system provided in a filtration configuration;

FIG. 8 is a schematic representation of a three-way valve system provided in a backwash configuration;

FIG. 9 is a schematic representation of a three-way valve system provided in a bypass configuration;

FIG. 10 is a schematic representation of a multi-port valve provided in a filtration configuration;

FIG. 11 is a schematic representation of a multi-port valve provided in a backwash configuration;

FIG. 12 is a schematic representation of a multi-port valve provided in a bypass configuration;

FIG. 13 is a flow chart illustrating a method for operating a multi-filter module filter assembly in a filtration configuration or a backwash configuration;

FIG. 14 is a flow chart illustrating a method for operating a multi-filter module filter assembly in a diagnostics operational configuration;

FIG. 15 is a flow chart illustrating a method for operating a multi-filter module filter assembly in a backwash operational configuration;

FIG. 16 is a flow chart illustrating a method for operating a multi-filter module filter assembly in a chemical cleaning operational configuration;

FIG. 17 is a flow chart illustrating a method for operating a multi-filter module filter assembly;

FIG. 18 is a flow chart illustrating a method for scheduling a backwash cleaning operation and a chemical cleaning operation for a multi-filter module filter assembly; and

FIG. 19 is a flow chart illustrating a method for scheduling a backwash cleaning operation and/or a chemical cleaning operation for a multi-filter module filter assembly.

### DETAILED DESCRIPTION

Before any instances are described in detail, it is to be understood that the disclosure is not limited in its application to the details of construction and the arrangement of components set forth in the following description or illustrated in the following drawings, which is limited only by the claims that follow the present disclosure. The disclosure is capable of other instances, and of being practiced, or of being carried out, in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof, as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use instances of the disclosure. Various modifications to the illustrated instances will be readily apparent to those skilled in the art, and the generic principles herein may be applied to other instances and applications without departing from the instances of the disclosure. Thus, instances of the disclosure are not intended to be limited to the instances shown but are to be accorded the widest scope consistent with the principles and features disclosed herein. The following detailed description is to be read with reference to the figures, in which like elements in different figures have like reference numerals. Skilled artisans will recognize the examples provided herein as having many useful alternatives and falling within the scope of instances of the disclosure.

Additionally, while the following discussion may describe features associated with specific devices, it is understood that additional devices and/or features may be used with the described systems and methods, and that the discussed devices and features are used to provide examples of possible instances without being limited.

The present disclosure provides a multi-filter modular pack assembly designed for use in an aquatic application (e.g., a pool or spa). The multi-filter modular assembly is provided in the form of a modular pack assembly, including a plurality of filtration modules. Each of the filtration modules is enclosed within an individual filtration module housing. The plurality of filtration modules and associated filtration module housings are entirely retained and/or enclosed within a single vessel (e.g., an outer housing). A plurality of valves positioned between the plurality of filtration modules are designed to independently control a flow of a fluid to and from each filtration module of the plurality of filtration modules. Thus, an individual filtration module may be backwashed and/or cleaned without the remaining individual filtration modules undergoing backwashing or cleaning. Therefore, a fouled filtration module may be targeted during a backwash or cleaning procedure.

In some implementations, the plurality of filtration modules includes various filtration module types. For example, each of the individual filtration modules may be provided in the form of a diatomaceous earth filter, a pressure-fed sand filter, a gravity sand filter, a cartridge filter, a reverse osmosis (“RO”) filter, a hollow fiber membrane filter, or a silicon carbide (“SiC”) filter. As an additional example, each of the individual filtration modules may be designed to filter macroscopic-sized debris, micron-sized particles, nano-sized particles, and/or larger or smaller particles from a fluid stream. Thus, the multi-filter module system may capture both large and small suspended solids in an aquatic system and may filter out contaminants such as skin cells, pollen, algae spores, and microorganisms, such as bacteria and viruses, that may not be effectively filtered out in traditional pool and spa filtration systems. Therefore, the multi-filter module system may provide improved water clarity, decreased disinfection by-product formation, decreased demand for a primary recreational water sanitizer and balancer, and more consistent sanitizer and balancer levels in the water.

The multi-filter modular pack assembly is designed to operate as a filtration device within a body of water or aquatic application, particularly a pool or spa system, to supplement and/or entirely replace a main filter, such as a traditional sand, cartridge, or diatomaceous earth filter.

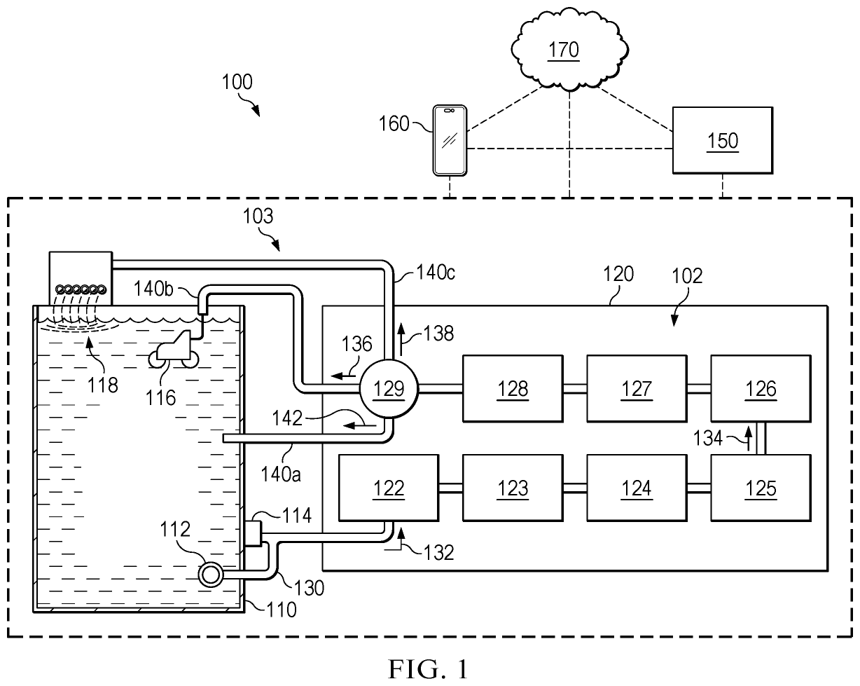

Referring to FIG. 1, a block diagram of an aquatic application 100 is depicted. The aquatic application 100 may be provided in the form of one or more swimming pool components 102, which may be designed for use with a swimming pool 110. The one or more swimming pool components 102 include plumbing (e.g., conduits) and one or more pool management devices that form a closed-loop fluid circuit. In some instances, a pool and spa recirculation system 103 may include, or be provided in the form of, the closed-loop fluid circuit. The one or more swimming pool components 102 may include a variable speed pump 122, a booster pump 123, a filter 124, a heater 125, a sanitizer 126, a water chemistry monitor 127, a water chemistry regulator 128, one or more valves 129, one or more of an inlet conduit 130, and one or more discharge conduits 140a-140c. One or more of the one or more swimming pool components 102 may be located on a pool pad 120.

An untreated flow of water 132 may flow from the swimming pool 110 through the inlet conduit 130 from a drain 112 and/or a skimmer 114 and to a suction side of the variable speed pump 122. The variable speed pump 122 and the booster pump 123 may be disposed upstream of the one or more swimming pool components 102 and may be in fluid communication with one or more of the one or more swimming pool components 102. The variable speed pump 122 and/or the booster pump 123 may provide a driving force for the untreated flow of water 132 to flow through the other downstream swimming pool components 102. A partially treated flow of water 134 may flow between the one or more swimming pool components 102. After the partially treated flow of water 134 has been treated by the one or more swimming pool components 102, a first treated flow of water 136, a second treated flow of water 138, and a third treated flow of water 142 may be provided to a first discharge conduit 140a, a second discharge conduit 140b, and a third discharge conduit 140c. In some instances, the first, second, or third treated flow of water 136, 138, 142 may be optionally provided directly to the swimming pool 110 and/or provided to a pool cleaner 116 and a water feature 118. It is to be understood that the untreated flow of water 132 may be dosed with one or more chemicals before being provided from the swimming pool 110 to the one or more swimming pool components 102. For example, a user may dose the water provided in the swimming pool 110 with one or more chemical agents (e.g., a solid alkalinity agent) before the water in the swimming pool 110 is provided as the untreated flow of water 132 to the one or more swimming pool components 102. In other instances, the untreated flow of water 132 may not be dosed or treated with chemical agents before being provided to the one or more swimming pool components 102.

In some instances, the sanitizer 126 and the water chemistry regulator 128 may be designed to control one or more water treatment chemicals that may be added to the swimming pool 110. For example, in some instances, the sanitizer 126 is designed to add chlorine and/or bromine to the aquatic application 100. In some instances, the water chemistry regulator 128 is designed to add one or more pool chemicals such as hydrochloric acid, sodium bisulfate, carbon dioxide, sulfuric acid, sodium carbonate, or other water treatment chemicals to the aquatic application 100. Further, the heater 125 is optionally included and is designed to heat the water in the aquatic application 100.

It is to be understood that the one or more swimming pool components 102 may be provided in various configurations (i.e., the order of the one or more swimming pool components 102 may be altered). Further, in some instances, the one or more swimming pool components 102 may be omitted or removed from the aquatic application 100.

Still referring to FIG. 1, the aquatic application 100 may further include a central controller 150 and a user device 160 that may interface with the central controller 150 either directly over a local area network or via a cloud network 170. The central controller 150 may be a gateway, a hub, a switch, a router, a server, or other connection device to allow integration, monitoring, and control of multiple aspects of the aquatic application 100. The user device 160 may be provided in the form of a cell phone, tablet, or any other similar portable electronic device that may include a camera and a user interface. The user device 160 may include native, mobile, or web-based applications to facilitate user communication with the central controller 150.

The central controller 150 may be designed to control the function and/or output of one or more components of the aquatic application 100 by sending instructions to, collecting data from, or monitoring the operation of one or more of the components of the aquatic application 100. Additionally, the central controller 150 may communicate information to a user of the aquatic application 100, a servicer of the aquatic application 100, or a person or company by sending notifications, alerts, or information to the user device 160.

The central controller 150 may also receive electronic signals from one or more of the swimming pool components 102, such as, for example, the variable speed pump 122, the booster pump 123, the filter 124, the heater 125, the sanitizer 126, the water chemistry monitor 127, the water chemistry regulator 128, the one or more valves 129, the inlet conduit 130, and the one or more discharge conduits 140a-140c. In some instances, one or more of the variable speed pump 122, the booster pump 123, the filter 124, the heater 125, the sanitizer 126, the water chemistry monitor 127, the water chemistry regulator 128, the one or more valves 129, the inlet conduit 130, or the one or more discharge conduits 140a-140c may include one or more sensors that detect data and/or collect measurements regarding pressure, flow rate, total dissolved solids, conductivity, pH level, or the temperature of the water at various locations in the aquatic application 100. Electronic signals may be sent continuously in real time, frequently, or periodically from the one or more sensors to provide data to the central controller 150. In some instances, the central controller 150 may instruct a change in one or more components of the aquatic application 100 in response to a reading from one or more of the aforementioned sensors. It is to be appreciated that the central controller 150 may instruct a change in any of the components of the aquatic application 100 more than once.

The central controller 150 may direct a desired water flow through the inlet conduit 130, the variable speed pump 122, the booster pump 123, the filter 124, the heater 125, the sanitizer 126, the water chemistry monitor 127, the water chemistry regulator 128, the one or more valves 129, and the one or more discharge conduits 140a-140c. In some instances, the central controller 150 may send an electronic signal to one or more of the conduits, valves, and pumps within the aquatic application 100 to allow water flow into, through, or out of the aquatic application 100 or to start, stop, or increase or decrease speed.

The central controller 150 may communicate warnings identifying or describing an issue (e.g., a detected carbon dioxide content is outside of a safe or acceptable range, a pH is too high/low to determine alkalinity, etc.) or a component problem (e.g., a component is not working, is operating outside of specification, or is otherwise not operating efficiently). The alert may be followed by or occur simultaneously with the central controller 150 taking an automatic action to address the issue or suggesting an action to be performed by the user device 160 or manually by a user when manual intervention is necessary. The central controller 150 may detect an issue in one or more of the swimming pool components 102 by, for example, receiving notice from one or more of the aforementioned sensors.

In some instances, a lookup table of predetermined values, thresholds, ranges, and other information may be stored by the central controller 150. Furthermore, the central controller 150 may be in communication with a network, for example, cloud network 170, and may be capable of downloading lookup tables. The central controller 150 may select threshold values (e.g., a threshold pH value, a threshold dissolved carbon dioxide value) from the lookup tables based on a number of factors, including a determined pressure, flow rate, temperature, pH, alkalinity, and/or other parameters. In addition, the predetermined values, thresholds, ranges, and other information described with reference to any of the methods described herein may be manually implemented or otherwise input into the central controller 150 by the user device 160.

Although FIG. 1 depicts the central controller 150 in communication with the user device 160 and the cloud network 170, it should be noted that various communication methodologies and connections may be implemented to work in conjunction with, or independent from, one or more local controllers associated with one or more individual components associated with the aquatic application 100 (e.g., a controller within the water chemistry regulator 128, e.g., a pump controller, a heater controller, etc.).

In some instances, machine learning (ML), artificial intelligence (AI), or similar processes may be implemented to iteratively train the central controller 150 and improve the performance of the one or more swimming pool components 102 based on one or more feedback parameters, characteristics, or similar information. For example, in some instances, ML/AI may be used to predict a membrane filter cleaning interval or water parameter threshold values. In some instances, ML/AI may be used to provide accurate water parameter testing and/or predict membrane filter load trends. Thus, the aquatic application 100 may be optimized to efficiently test and clean the filter 124.

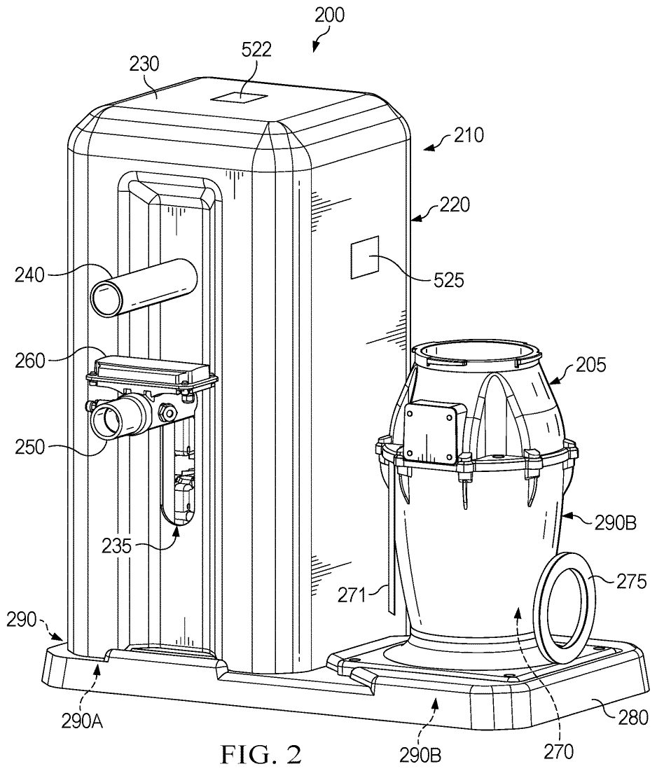

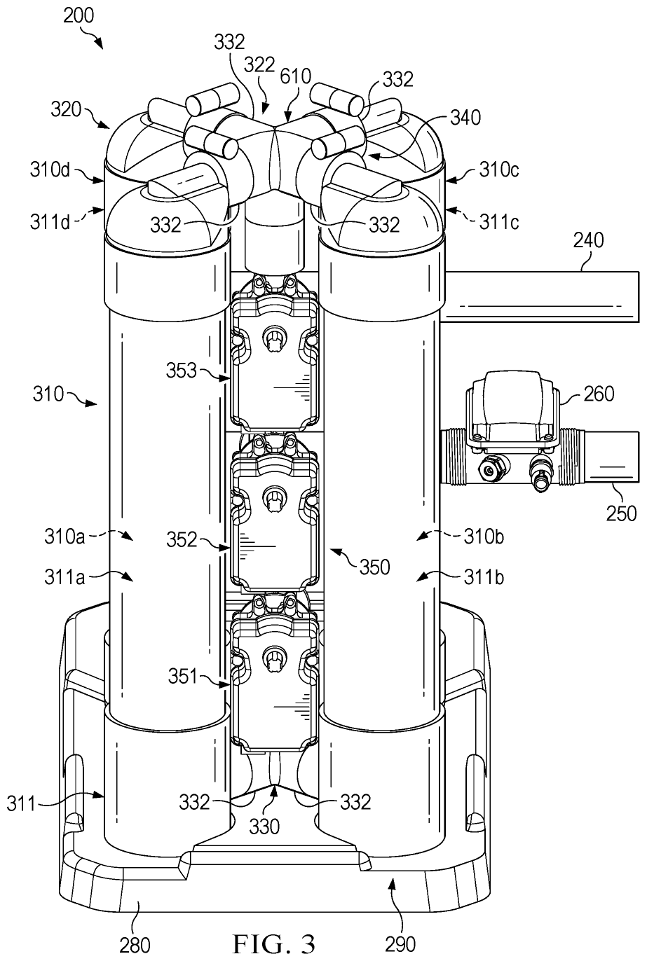

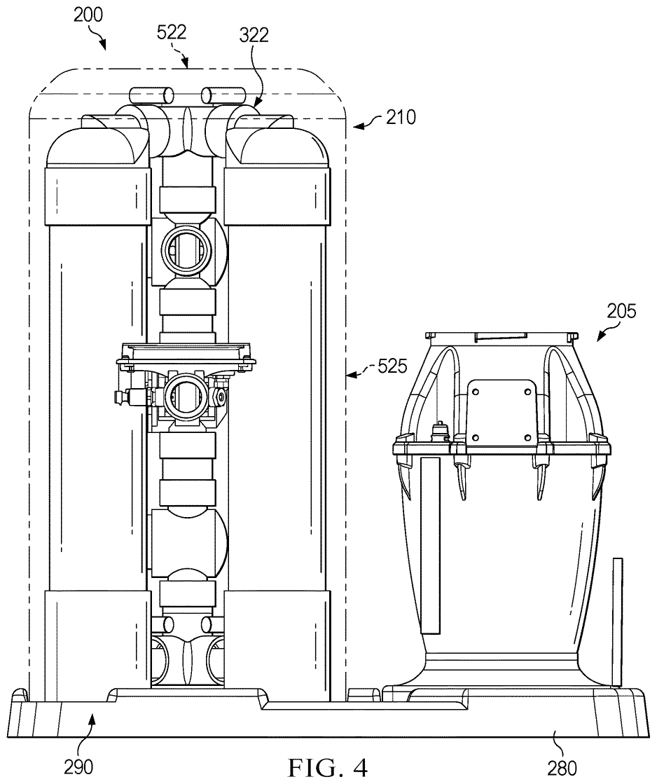

Turning to FIG. 2, a multi-filter modular pack assembly 200 and a chemical feed tank 205 are shown, according to one instance of the disclosure. In some instances, the multi-filter modular pack assembly 200 may be the filter 124 of FIG. 1. The multi-filter modular pack assembly 200 is provided in the form of an outer housing or vessel 210, including a plurality of filtration modules enclosed entirely within the outer housing or vessel 210, which is discussed further with reference to FIGS. 3 and 4. As shown, the vessel 210 may be provided in the form of a substantially rectangular prism. However, it is to be understood that the vessel 210 may be provided in the form of any other three-dimensional geometry, including, but not limited to, a cylinder or a hexagonal prism. The vessel 210 may be made from polymeric materials, such as thermoplastics, which may have inherent resistance to common environmental and chemical stressors, although the vessel 210 may also be provided in the form of other materials.

In some instances, the vessel 210 may be provided in the form of a main body 220 and a lid 230 coupled to the main body 220. In some instances, the main body 220 and the lid 230 may be arranged or coupled together to form a substantially enclosed interior. In some instances, the lid 230 may be removable from the main body 220. In other instances, the lid 230 may be selectively opened to provide access to the interior of the vessel 210. For example, the lid 230 may be coupled to the main body 220 by a rotatable attachment mechanism. Thus, the internal components of the multi-filter modular pack assembly 200 may be accessed. In other instances, the lid 230 may be integrally formed with the main body 220, and the interior of the vessel 210 may be accessed through other access ports or access doors provided in the main body 220. In some cases, the main body 220 may include a cutout 235 through which the interior of the main body 220 may be viewed and/or accessed, although the cutout 235 may be omitted from the main body 220.

The vessel 210 may include one or more ports for connecting additional components to the multi-filter modular pack assembly 200. In some instances, such as in FIG. 2, the main body 220 includes an inlet port 240 and an outlet port 250. One or both of the inlet port 240 and the outlet port 250 may be provided in the form of plumbing or conduits designed to carry a fluid stream, such as water. The inlet port 240 may permit fluid to flow into the multi-filter modular pack assembly 200, and the outlet port 250 may permit fluid to exit the multi-filter modular pack assembly 200. The inlet port 240 and the outlet port 250 may be in fluid communication with the one or more swimming pool components 102 of the aquatic application 100 of FIG. 1.

Additional ports (not shown) may be included in the vessel 210. The additional ports may be employed to provide additional benefits, such as placing the vessel 210 in fluid communication with a waste line. The waste line may be designed to direct fluid to a waste system, pressure relief (e.g., a connection for a pressure relief valve), one or more connection points for supplemental operational status indicators through externally connected devices, such as gauges or transducers, and/or connection points to the one or more swimming pool components 102 included in or on the pool pad 120. In other instances, the supplemental devices could be provided as internally connected devices. Non-limiting examples of internally connected devices may include level sensors, pressure sensors, and flow detectors.

In some aspects, one or more external devices may be in fluid communication with the multi-filter modular pack assembly 200. For example, measurement devices or monitors may be coupled to the inlet port 240 and/or the outlet port 250. As shown in FIG. 2, a pressure and flow monitor 260 is coupled to the outlet port 250. The pressure and flow monitor 260 may be designed to measure, monitor, or otherwise sense pressure and flow data from a flow of water through the pressure and flow monitor 260. The pressure and flow monitor 260 may be communicatively coupled to the central controller 150 of FIG. 1, such that the central controller 150 may receive the pressure and flow data sensed by the pressure and flow monitor 260. The central controller 150 may control one or more internal components of the multi-filter modular pack assembly 200 based on the received pressure and flow data, as discussed in more detail with reference to FIGS. 3-19. In some instances, the pressure and flow monitor 260 may be coupled to the inlet port 240. In other instances, the pressure and flow monitor 260 may be coupled to the outlet port 250. In further instances, a first pressure and flowmeter is coupled to the outlet port 250, and a second pressure and flowmeter is coupled to the inlet port 240.

Referring still to FIG. 2, the chemical feed tank 205 may include a chemical cleaning agent 270 therein and may be in fluid communication with the multi-filter modular pack assembly 200. The chemical cleaning agent may be provided in the form of any chemical that is designed to modify, regulate, or control one or more water chemistry parameters or physical parameters of pool water. For example, the chemical cleaning agent may be provided in the form of chlorine, bromine, calcium hypochlorite, trichloroisocyanuric acid, dichloro-s-triazinetrione, other cleaning and/or bleaching agents, and combinations thereof. In other instances, the chemical cleaning agent may be selected from the group consisting of chlorine, bromine, calcium hypochlorite, trichloroisocyanuric acid, dichloro-s-triazinetrione, other cleaning and/or bleaching agents, and combinations thereof.

In some examples, the chemical feed tank 205 is fluidly connected to the multi-filter modular pack assembly 200 via a chemical feed line (not shown) that may place the chemical feed tank 205 in fluid communication with the inlet port 240. In some aspects, the chemical feed tank 205 may be fluidly connected to the multi-filter modular pack assembly 200 via a chemical feed line (not depicted) that may be in fluid communication with the outlet port 250. In other implementations, the chemical feed tank 205 is fluidly connected to the multi-filter modular pack assembly 200 via a chemical feed line that may be in fluid communication with an additional port of the multi-filter modular pack assembly 200, as discussed herein. In each instance, the chemical feed line may include a chemical feed line control valve designed to control the flow of the chemical cleaning agent 270 through the chemical feed line.

In some cases, the chemical feed tank 205 may include a lid 275. The lid 275 may be selectively coupled to the chemical feed tank 205 such that an interior of the chemical feed tank 205 may be accessed by removing or lifting the lid 275 from the chemical feed tank 205. The lid 275 may be selectively coupled to the chemical feed tank by any suitable fasteners, including, but not limited to, a screw top, a hinge, one or more fasteners, or one or more snap-fit tabs.

In some cases, the multi-filter modular pack assembly 200 and/or the chemical feed tank 205 may be positioned atop a base pan 280. The base pan 280 may generally be provided in the form of a rectangular prism with one or more recesses 290 provided on a top surface of the base pan 280, although the base pan 280 may also be provided in other shapes and forms. In some instances, the base pan 280 may include a first recess 290a and a second recess 290b. In certain instances, the one or more recesses 290 may be shaped such that the chemical feed tank 205 and/or the multi-filter modular pack assembly 200 may be received therein.

Further, in some instances, the chemical feed tank 205 utilizes a pump (such as the pump 122 or the booster pump 123 of FIG. 1) to provide a driving force for delivering the chemical cleaning agent 270 to the multi-filter modular pack assembly 200. In some examples, the pump may be the variable speed pump 122 and/or the booster pump 123 of FIG. 1. In other instances, the chemical feed line may include a separate dosing pump that is in fluid communication with the chemical feed line.

Turning to FIGS. 3 and 4, various internal components of the multi-filter modular pack assembly 200 of FIG. 2 are shown. The multi-filter modular pack assembly 200 may include a plurality of filtration modules 310. Each filtration module of the plurality of filtration modules 310 may be operated under the principle of using pressure-driven filtration.

As shown best in FIG. 3, the plurality of filtration modules 310 may be provided in the form of four individual filtration modules (e.g., a first filtration module 310a, a second filtration module 310b, a third filtration module 310c, and a fourth filtration module 310d). Each filtration module of the plurality of filtration modules 310 may be independently selected or designed to filter macroscopic-sized debris, micron-sized particles, nano-sized particles, and/or larger or smaller particles from a fluid stream, although each filtration module may also be selected or designed to filter the same sized particles. In various instances, the multi-filter modular pack assembly 200 may include more or fewer filtration modules than four, depending on the needs of the system and/or the user. For example, the plurality of filtration modules 310 may include two filtration modules, three filtration modules, five filtration modules, six filtration modules, or more.

Each filtration module of the plurality of filtration modules 310 may be individually provided in the form of a diatomaceous earth filter, a pressure-fed sand filter, a gravity sand filter, a cartridge filter, an RO filter, a hollow fiber membrane filter, or a SiC filter. Thus, in some instances, the plurality of filtration modules 310 may all be provided in the form of the same type of filter. In other instances, the plurality of filtration modules 310 includes two or more filter types. For example, the first filtration module 310a may be provided in the form of a diatomaceous earth filter, while the second filtration module 310b may be provided in the form of a hollow fiber filtration module. Thus, the multi-filter modular pack assembly 200 may be designed to capture contaminants of various sizes.

Each filtration module of the plurality of filtration modules 310 is contained, enclosed, and/or received within a module housing. Accordingly, the multi-filter modular pack assembly 200 includes a plurality of filtration module housings 311 equivalent to the number of the plurality of filtration modules 310. Thus, according to the example shown in FIG. 3, the multi-filter modular pack assembly 200 includes a first filtration module housing 311a designed to contain the first filtration module 310a, a second filtration module housing 311b designed to contain the second filtration module 310b, a third filtration module housing 311c designed to contain the third filtration module 310c, and a fourth filtration module housing 311d designed to contain the fourth filtration module 310d. As such, an internal portion of the vessel 210 may remain dry because the plurality of filtration module housings contains the fluid passing through the multi-filter modular pack assembly 200.

As discussed with reference to FIG. 2, fluid from the aquatic application 100 may enter the multi-filter modular pack assembly 200 through the inlet port 240, and fluid may exit the multi-filter modular pack assembly 200 through the outlet port 250. Accordingly, the multi-filter modular pack assembly 200 may include an internal fluid distribution system 320 designed to direct the fluid flow through one or more of the filtration modules of the plurality of filtration modules 310.

The internal fluid distribution system 320 includes a manifold 322 provided in the form of a first portion 330 and a second portion 340. Together, the first portion 330 and the second portion 340 of the manifold 322 may secure the plurality of filtration modules 310 in a generally vertical or upright configuration within the multi-filter modular pack assembly 200. The first portion 330 of the manifold 322 may engage with a first end of the plurality of filtration module housings 311, and the second portion 340 of the manifold 322 may engage with a second end of the plurality of filtration module housings 311. In other instances, the manifold 322 and the plurality of filtration modules 310 may be disposed in other orientations.

Each of the first portion 330 and the second portion 340 of the manifold 322 includes a plurality of arms 332. In some instances, the plurality of arms 332 may be equivalent to the number of the plurality of filtration modules 310, although in some instances a filtration module may be omitted from an arm of the plurality of arms 332. The plurality of arms 332 extends from a center portion of each respective manifold portion. Each of the plurality of arms 332 may include a module receiver designed to engage with a filtration module housing. Each module receiver may include a filtration module inlet or a filtration module outlet for directing fluid into and/or out of the individual filtration module. Thus, the number of filtration module inlets and the number of filtration module outlets may be equivalent to the number of the plurality of filtration modules 310 (e.g., the first portion 330 of the manifold 322 includes a plurality of filtration module inlets and the second portion 340 of the manifold 322 includes a plurality of filtration module outlets).

The plurality of filtration module inlets and the plurality of filtration module outlets may be substantially similar in design. However, their functionality (e.g., function of directing fluid into the plurality of filtration modules 310 or directing fluid out of the plurality of filtration modules) may be determined based on which portion of the manifold 322 the filtration module inlet or the filtration module outlet is located in. Thus, the first portion 330 and the second portion 340 of the manifold 322 may substantially mirror each other. Therefore, when the plurality of filtration modules 310 are connected, a fluid circuit is formed between the first portion 330 of the manifold 322, the second portion 340 of the manifold 322, and the plurality of filtration modules 310 positioned between the first portion 330 and the second portion 340 of the manifold 322.

In some instances, the plurality of filtration modules 310 may be arranged in a parallel fluid circuit. Thus, in the fluid circuit, the plurality of filtration module inlets may direct an unfiltered or pre-filtered fluid received from an aquatic application (such as aquatic application 100 of FIG. 1) from the inlet port 240 to each of the filtration modules of the plurality of filtration modules 310. The plurality of filtration modules 310 may filter the unfiltered or pre-filtered fluid, generating a filtered fluid. Accordingly, the plurality of filtration module outlets may direct the filtered fluid, also referred to as the filtration module permeate, back to the aquatic application (such as the aquatic application 100 of FIG. 1) through the outlet port 250. In other instances, the plurality of filtration modules 310 may be arranged in a series fluid circuit, or the plurality of filtration modules 310 may be arranged in series and in parallel.

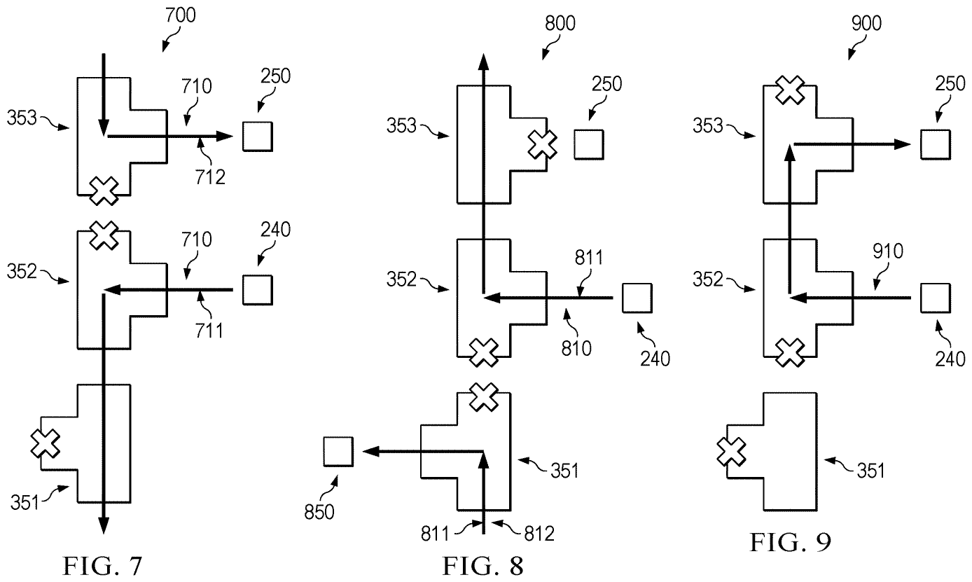

The multi-filter modular pack assembly 200 may further include one or more valves 350 designed to direct a fluid flow through the fluid circuit formed between the first portion 330 and the second portion 340 of the manifold 322. The one or more valves 350 may be provided in the form of a three-way valve or a multi-port valve. In other instances, the one or more valves 350 may be provided in other forms, such as a multi-way valve. Further, the one or more valves 350 may be communicatively coupled to the central controller 150, discussed with reference to FIG. 1. Thus, as discussed in more detail with reference to FIGS. 7-12, the central controller 150 may remotely control a valve position of one or more valves 350 to direct the fluid flow through the multi-filter modular pack assembly 200.

In some instances, as shown in FIGS. 3 and 4, the one or more valves 350 may be provided in the form of three three-way valves, and may include a first valve 351, a second valve 352, and a third valve 353. The one or more valves 350 may be positioned in a center portion of the interior of the multi-filter modular pack assembly 200 and/or between two or more of the plurality of filtration modules 310.

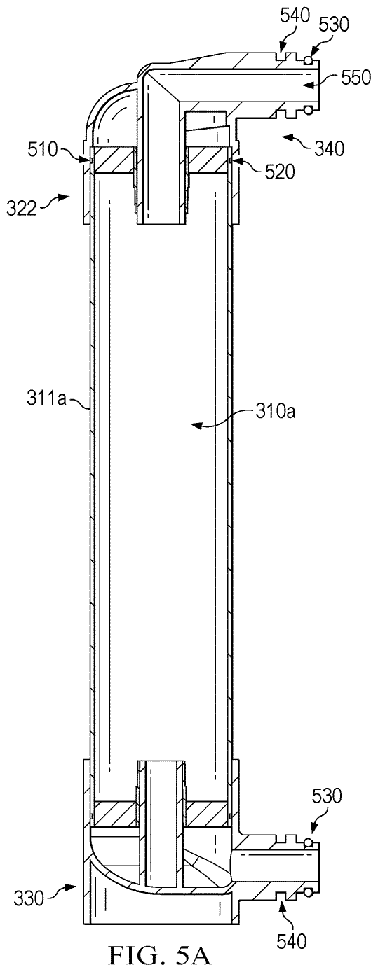

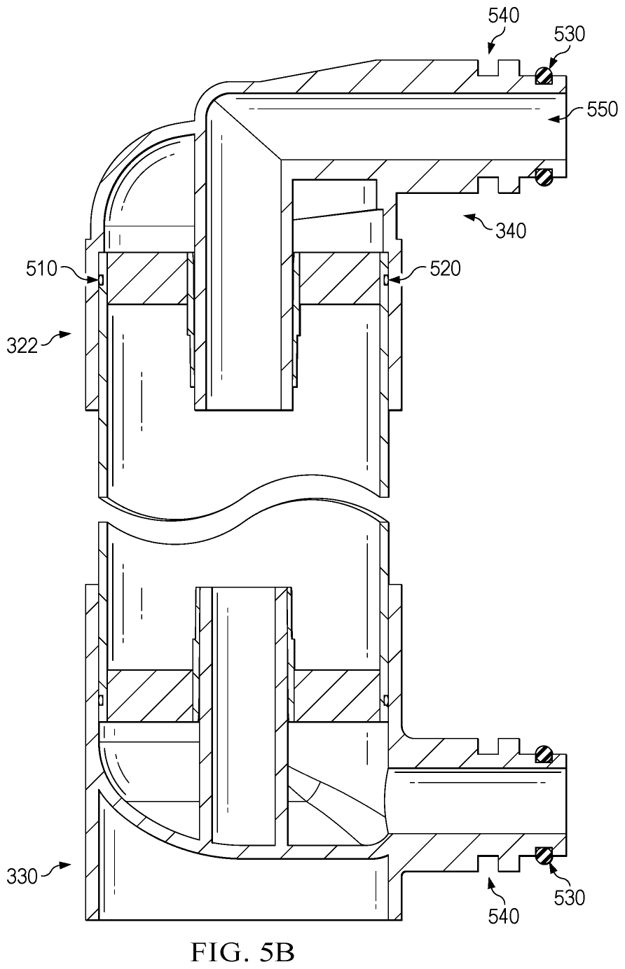

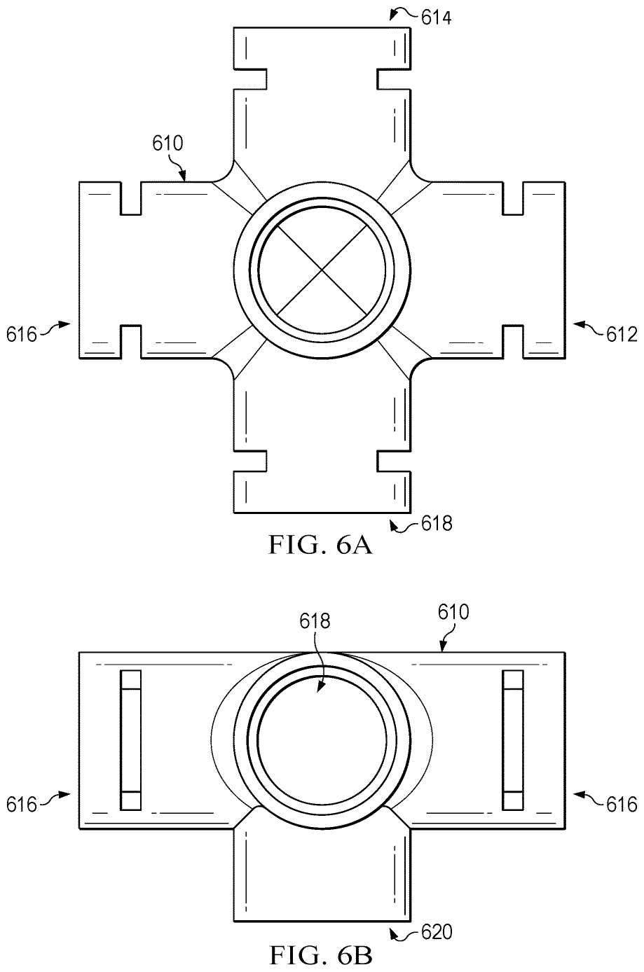

FIGS. 5A, 5B, 6A, and 6B further illustrate the first portion 330 and the second portion 340 of the manifold 322 in relation to the first filtration module 310a and the first filtration module housing 311a. As shown in FIGS. 5A and 5B, the second portion 340 of the manifold 322 may include an air bleed 510 and a dosing port 520. In addition, referring back to FIG. 4, a corresponding air bleed port 522 and a chemical dosing port 525 may extend through the outer housing or vessel 210. It is to be appreciated that the locations of the air bleed 510, dosing port 520, the air bleed port 522, and the chemical dosing port 525 are not particularly limited. The air bleed port 522 and the chemical dosing port 525 may be placed in fluid communication with the air bleed 510 and the dosing port 520, respectively, by one or more conduits (not depicted). In some instances, the first portion 330 or other portions of the manifold 322 may include or be provided with one or more air bleeds and/or one or more dosing ports. In some instances, each of a plurality of filtration modules (such as the plurality of filtration modules 310 of FIG. 3) may be provided with an air bleed port and a dosing port (such as the air bleed 510 and the dosing port 520 of FIGS. 5A and 5B). In other instances, the manifold 322 may include a single air bleed port and a single dosing port that are each in fluid communication with each filtration module of the plurality of filtration modules 310.

Additionally, as provided in FIGS. 5A and 5B, each of the first portion 330 and the second portion 340 of the manifold 322 may include one or more radial seals 530 and one or more e-clips 540. The one or more radial seals 530 may be designed to provide a substantially watertight or watertight seal between the second portion 340 of the manifold and the one or more isolation valves 610 (see FIGS. 6A and 6B). The one or more e-clips 540 may be designed to secure one or more components, including those discussed herein, to the manifold 322. In some instances, the one or more e-clips 540 may be omitted from the manifold 322. The second portion 340 may include a water outlet 550, wherein clean water may exit the assembly through the water outlet 550.

In some instances, a volume of air may become trapped in the manifold 322. The air bleed 510 may be designed to release the volume of air from the manifold 322. As such, the air bleed 510 and the air bleed port 522 may be positioned at or near a top portion of the manifold 322 and the outer housing or vessel 210 to facilitate the release of the volume of air through the air bleed 510 and the air bleed port 522. The dosing port 520 may be in fluid communication with the chemical feed tank 205. The dosing port 520 may be designed to introduce one or more chemicals into the manifold 322 to help facilitate a chemical cleaning of a filtration module of the plurality of filtration modules 310. Alternatively, the chemical feed tank 205 may be in fluid communication with dosing ports (e.g., the dosing port 520) provided in the plurality of filtration module housings 311.

As best seen in FIGS. 3, 6A, and 6B, in some examples, the multi-filter modular pack assembly 200 includes one or more isolation valves 610 designed to isolate one or more of the plurality of filtration modules 310 from any of the other one or more filtration modules 310 within a particular filter pack modular assembly (such as the multi-filter pack modular assembly 200 of FIG. 2). In some instances, each filtration module of the plurality of filtration modules 310 may include an isolation valve 610. In other instances, one or more isolation valves 610 may be positioned at or near the second portion 340 to control fluid flow to each of the plurality of filtration modules 310. In some instances, the isolation valves 610 may be used to prevent a flow of fluid to and/or from various portions of the multi-filter modular pack assembly 200. Thus, a flow to and/or from each of the plurality of filtration modules 310 may be isolated from the remainder of the plurality of filtration modules 310.

In some instances, the one or more isolation valves 610 may be provided with a first opening 612, a second opening 614, a third opening 616, a fourth opening 618, and a fifth opening 620. Each of the first opening 612, the second opening 614, the third opening 616, and the fourth opening 618 may be placed in fluid communication with one or more filtration modules (e.g., the plurality of filtration modules 310 of FIG. 3). The fifth opening 620 may be placed in fluid communication with one or more valves (e.g., the one or more valves 350 of FIG. 3). Each of the first opening 612, the second opening 614, the third opening 616, the fourth opening 618, and the fifth opening 620 may be designed to selectively open and close such that the component each opening may be in fluid communication with may be isolated from the remaining elements. It is to be understood that in some instances the one or more isolation valves 610 may include a lesser or greater number of openings, depending on the number of filtration modules and/or valves in a particular system. In addition, the first opening 612, the second opening 614, the third opening 616, the fourth opening 618, and the fifth opening 620 may be alternatively arranged and/or coupled to other components of the multi-filter modular pack assembly 200 than described herein.

It may be beneficial to isolate one or more of the plurality of filtration modules 310 because each of the plurality of filtration modules 310 may foul at different rates. For example, the first filtration module 310a may foul before the second, third, or fourth filtration modules 310b-d foul. For example, when the plurality of filtration modules 310 includes two or more types of filtration modules, the different types of filtration modules of the plurality of filtration modules 310 may foul at different rates. Thus, a fouled filtration module may be isolated (e.g., via actuation of the one or more isolation valves 610) from the remainder of the plurality of filtration modules 310 during a filtration operation so that the entire multi-filter modular pack assembly 200 does not need to be shut down. In other instances, during a cleaning procedure (e.g., a backwash operation or a chemical cleaning operation) the clean or less fouled filtration modules may be isolated so that the cleaning operation may be focused on the fouled filtration module. Accordingly, the multi-filter modular pack assembly 200 may include one or more of pressure and/or flowmeters designed to sense a fouled state of each of the plurality of filtration modules 310.

For example, in instances where one or more of a pressure and/or flowmeter are provided, such as the pressure and flow monitor 260 of FIGS. 2 and 3, the one or more of a pressure and/or flowmeter may periodically or continuously sense or measure one or more of an inlet pressure at the inlet port 240, an outlet pressure at the outlet port 250, a module pressure at or within one or more of the plurality of filtration modules 310, and/or a system flow rate through the multi-filter modular pack assembly 200. If one of the plurality of filtration modules 310 accumulates contaminants or other fouling materials and begins to foul, a measurable change in one or more of these sensed parameters may occur. For instance, fouling of one or more of the plurality of filtration modules 310 may cause an increase in the inlet pressure or a decrease in the outlet pressure, resulting in an elevated differential pressure across the affected filtration module or across the multi-filter modular pack assembly 200 as a whole. Additionally, or alternatively, fouling of one or more of the plurality of filtration modules 310 may cause a reduction in the system flow rate, as the accumulation of contaminants within the filtration media restricts the passage of fluid through the affected filtration module.

In such instances, the central controller 150 may receive the sensed pressure and flow data from one or more of the pressure and/or flowmeter and compare one or more of the sensed parameters, or values derived therefrom, to one or more predetermined threshold values. When the sensed or derived value exceeds or falls below the applicable threshold value, the central controller 150 may determine that one or more of the plurality of filtration modules 310 is in a fouled state and may initiate a cleaning procedure as described herein. In some instances, the central controller 150 may be designed to confirm that the sensed or derived value satisfies the applicable threshold condition for a threshold time period before determining that a fouled state exists, thereby preventing a false positive detection due to transient fluctuations in pressure or flow. In other instances, the central controller 150 may be designed to identify which individual filtration module or modules of the plurality of filtration modules 310 are fouled based on pressure measurements obtained at or near each individual filtration module (e.g., via one or more sensors positioned within or adjacent to the plurality of filtration module housings 311), and may isolate one or more fouled filtration modules using the one or more isolation valves 610 while the remaining filtration modules of the plurality of filtration modules 310 continue to operate in the filtration mode.

FIGS. 7-9 are schematic diagrams of various valve configurations of one or more valves, such as the one or more valves 350 of FIG. 3 (e.g., the first valve 351, the second valve 352, and the third valve 353), when the one or more valves are provided in the form of three three-way valves. In the schematic diagrams of FIGS. 7-9, the arrows may represent the flow of a fluid, while the “X”s may represent locations in which fluid flow is prevented. Further, any directional information (e.g., upwardly, downwardly) discussed with reference to FIGS. 7-9 is made with reference to the surface upon which the multi-filter modular pack assembly 200 is positioned. It is to be appreciated that the fluid flow may be oriented in different directions to, through, and from the one or more valves 350 than described herein.

FIG. 7 is a schematic diagram showing a first valve configuration 700 of the first valve 351, the second valve 352, and the third valve 353 when the multi-filter modular pack assembly 200 is in a filtration mode. The first valve 351 may be in fluid communication with the inlet port 240 of FIG. 2, the first portion 330 of the manifold 322 of FIG. 3, and a waste line. The second valve 352 may be in fluid communication with the inlet port 240, the first valve 351, and the third valve 353. The third valve 353 may be in fluid communication with the outlet port 250 of FIG. 2, the second portion 340 of the manifold 322 of FIG. 3, and the second valve 352.

During the filtration mode, unfiltered or pre-filtered fluid enters the multi-filter modular pack assembly 200 through the inlet port 240 as shown by a fluid flow path 710. In the first valve configuration 700, the second valve 352 directs the unfiltered or pre-filtered fluid to the plurality of filtration modules 310 via the first valve 351. Accordingly, the second valve 352 is oriented in a first configuration, blocking the incoming fluid from flowing to the third valve 353. Further, the first valve 351 is oriented in a first configuration, directing the incoming fluid to the first portion 330 of the manifold 322 and blocking a flow path to the waste line. Thus, in a first portion 711 of the fluid flow path 710, the incoming fluid flows into the inlet port 240, through the second valve 352, through the first valve 351, and into the plurality of filtration modules 310.

In the filtration mode, the incoming fluid flows upwardly through the plurality of filtration modules 310, which, in turn, filters or cleans the fluid, generating filtered fluid. The filtered fluid exits the plurality of filtration modules 310 via the second portion 340 of the manifold 322 of FIG. 3. Accordingly, the third valve 353 is oriented in a first configuration, directing the filtered fluid back to the aquatic application 100 and blocking the filtered fluid from flowing into the second valve 352. Thus, in a second portion 712 of the fluid flow path 710, the filtered fluid flows through the second portion 340 of the manifold 322, through the third valve 353, through the outlet port 250, and back to the aquatic application 100.

FIG. 8 is a schematic diagram showing a second valve configuration 800 of the first valve 351, the second valve 352, and the third valve 353 when the multi-filter modular pack assembly 200 is in a backwash mode and/or a chemical cleaning mode. During the backwash mode, unfiltered or pre-filtered water from a source of water (e.g., the swimming pool 110 of FIG. 1) enters the multi-filter modular pack assembly 200 through the inlet port 240, as shown by a fluid flow path 810.

In the second valve configuration 800, the second valve 352 directs the incoming water to the plurality of filtration modules 310 via the third valve 353. Accordingly, the second valve 352 is oriented in a second configuration that blocks the incoming water from flowing to the first valve 351. Further, the third valve 353 is oriented in a second configuration, directing the incoming water to the second portion 340 of the manifold 322, and blocking a flow path of the water to the outlet port 250. Thus, in a first portion 811 of the fluid flow path 810, the incoming water flows into the inlet port 240, through the second valve 352, through the third valve 353, and into the plurality of filtration modules 310.

In use, in the backwash mode, the incoming fluid flows downwardly through the plurality of filtration modules 310. Thus, during the backwash mode, the flow through the multi-filter modular pack assembly 200 is reversed as compared to the filtration mode. In turn, the flow of fluid through the multi-filter modular pack assembly 200 may remove particulates from the multi-filter modular pack assembly 200 and help improve the filtering efficiency of the plurality of filtration modules 310. Accordingly, the first valve 351 is oriented in a second configuration, directing the backwash fluid (e.g., the fluid containing contaminants from the plurality of filtration modules 310) to a waste system 850. The waste system 850 may be provided in the form of a waste container, a waste conduit, and/or a drain. Therefore, in a second portion 812 of the fluid flow path 810, the backwash fluid flows through the first portion 330 of the manifold 322, through the first valve 351, and to the waste system 850. In various instances, the waste system 850 may be in fluid communication with a drain such that any waste fluid may be disposed of via the drain. In addition, or alternatively, the waste fluid provided from the waste system 850 may be directed to other components for further processing or for storage before reuse or disposal.

Similarly, in the chemical cleaning mode, a chemical cleaning agent (e.g., the chemical cleaning agent 270 of FIG. 2) enters the multi-filter modular pack assembly 200 through the inlet port 240. In the second valve configuration 800, the second valve 352 directs the chemical cleaning agent 270 to the plurality of filtration modules 310 via the third valve 353. Accordingly, the second valve 352 is oriented in a second configuration, blocking the chemical cleaning agent 270 from flowing to the first valve 351. Further, the third valve 353 is oriented in a second configuration, directing the chemical cleaning agent 270 to the second portion 340 of the manifold 322 and blocking a flow path to the outlet port 250. Thus, in a first portion 811 of the fluid flow path 810, the chemical cleaning agent 270 flows into the inlet port 240, through the second valve 352, through the third valve 353, and into the plurality of filtration modules 310.

In some instances, in the chemical cleaning mode, the chemical cleaning agent 270 flows downwardly through the plurality of filtration modules 310. Thus, during the chemical cleaning mode, the fluid flow through the multi-filter modular pack assembly 200 is reversed as compared to the filtration mode. Therefore, in addition to neutralizing contaminants, the chemical cleaning agent 270 may also remove particulates from the multi-filter modular pack assembly 200 and help improve the filtering efficiency of the plurality of filtration modules 310. Accordingly, the first valve 351 is oriented in a second configuration, directing the chemical cleaning agent 270 to a waste container, a waste conduit, and/or a drain. Therefore, in a second portion 812 of the fluid flow path 810, the chemical cleaning agent 270 flows through the first portion 330 of the manifold 322, through the first valve 351, and to a waste system.

In other instances, it may be beneficial to direct the chemical cleaning agent 270 back to the aquatic application (e.g., the aquatic application 100 of FIG. 1) after the chemical cleaning procedure because the remainder of the chemical cleaning agent 270 may be used to dose the fluid of the aquatic application. For example, in some instances, the chemical cleaning agent 270 may be provided in the form of chlorine. Thus, instead of going to a waste system, the chemical cleaning agent 270 may be directed back to the aquatic application. Accordingly, in some instances, the valve configuration during the chemical cleaning procedure may be similar to the first valve configuration 700 discussed with reference to FIG. 7.

For example, in such instances, the chemical cleaning agent 270 may enter the multi-filter modular pack assembly 200 through the inlet port 240. The second valve 352 directs the chemical cleaning agent 270 to one or more of the plurality of filtration modules 310 via the first valve 351. The second valve 352 is oriented in the first configuration (e.g., as discussed with reference to FIG. 7), blocking the chemical cleaning agent 270 from flowing to the third valve 353. Further, the first valve 351 is oriented in a first configuration, directing the chemical cleaning agent 270 to the first portion 330 of the manifold 322 and blocking a flow path to the waste line. Thus, the chemical cleaning agent 270 flows into the multi-filter modular pack assembly 200 via the inlet port 240, through the second valve 352, through the first valve 351, and into the plurality of filtration modules 310.

In use, in the chemical cleaning mode designed to direct the chemical cleaning agent 270 back to the aquatic application, the chemical cleaning agent 270 flows through the plurality of filtration modules 310 in a direction opposite to the filtration mode flow direction, which, in turn, cleans the plurality of filtration modules 310 (although it is to be appreciated that the chemical cleaning agent 270 may also flow through the plurality of filtration modules 310 in the same direction as the filtration mode flow direction). The chemical cleaning agent 270 exits the plurality of filtration modules 310 via the second portion 340 of the manifold 322. Accordingly, the third valve 353 is oriented in the first configuration (e.g., as discussed with reference to FIG. 7), directing the chemical cleaning agent 270 back to the aquatic application via the outlet port 250 and blocking the chemical cleaning agent 270 from flowing into the second valve 352, thereby preventing dilution or contamination of the chemical cleaning agent 270 within the system. Thus, the chemical cleaning agent 270 flows through the second portion 340 of the manifold 322, through the third valve 353, through the outlet port 250, and back to the aquatic application.

FIG. 9 is a schematic diagram showing a third valve configuration 900 of the first valve 351, the second valve 352, and the third valve 353 in a bypass mode. During the bypass mode, unfiltered or pre-filtered fluid enters the multi-filter modular pack assembly 200 through the inlet port 240, bypasses the plurality of filtration modules 310, and returns back to the aquatic application 100. In the third valve configuration 900, the second valve 352 is oriented in a third configuration that directs the incoming fluid toward the third valve 353 and onward to the outlet port 250. Accordingly, the second valve 352 is oriented in a third configuration that blocks the incoming fluid from flowing to the first valve 351. Further, the third valve 353 is oriented in a third configuration, directing the incoming fluid to the outlet port 250 and blocking the incoming fluid from flowing to the second portion 340 of the manifold 322, thereby ensuring that the plurality of filtration modules 310 are not exposed to uncontrolled fluid flow during the bypass mode. Accordingly, as shown by a fluid flow path 910, the incoming fluid flows into the inlet port 240, through the second valve 352, through the third valve 353, and back to the aquatic application 100 via the outlet port 250.

In other instances, the one or more valves 350 may be provided in the form of a single multi-port valve in fluid communication with the inlet port 240, the outlet port 250, the plurality of module inlets, the plurality of module outlets, and a waste line. FIGS. 10-12 are schematic diagrams of various valve configurations of a multi-port valve.

In some instances, the multi-port valve is provided as a multi-port valve 1000 of FIG. 10. The multi-port valve 1000 includes five ports, although in alternative instances the multi-port valve 1000 could include additional or fewer than five ports. A first port 1010 is in fluid communication with the aquatic application 100 via the inlet port 240. A second port 1020 is in fluid communication with the plurality of filtration module inlets via the first portion 330 of the manifold 322. A third port 1030 is in fluid communication with the plurality of filtration module outlets via the second portion 340 of the manifold 322. A fourth port 1040 is in fluid communication with the aquatic application 100 via the outlet port 250. A fifth port 1050 is in fluid communication with the waste system. Thus, the flow path of fluid through the multi-filter modular pack assembly 200 may be controlled by selectively opening and closing the first port 1010, the second port 1020, the third port 1030, the fourth port 1040, and/or the fifth port 1050 to place the multi-port valve 1000 in a desired valve configuration.

FIG. 10 is a schematic diagram showing a first valve configuration 1005 of the multi-port valve 1000 in a filtration mode and/or chemical cleaning mode. In the first valve configuration 1005, each of the first port 1010, the second port 1020, the third port 1030, and the fourth port 1040 are in a first open position. In the first open position, a fluid pathway may be formed between the first port 1010 and the second port 1020, depicted with a first stippling pattern. Thus, unfiltered or pre-filtered fluid from an aquatic application (e.g., the aquatic application 100 of FIG. 1) flows from the inlet port 240 into the multi-filter modular pack assembly 200 via the first port 1010 and into the plurality of filtration modules 310 via the second port 1020, which may be in fluid communication with the first portion 330 of the manifold 322.

Further, a fluid pathway is formed between the third port 1030 and the fourth port 1040, depicted by a second stippling pattern. Thus, the filtered water that passes through the plurality of filtration modules 310 is directed to the second portion 340 of the manifold 322, which is in fluid communication with the third port 1030. The filtered water is routed back to the aquatic application 100 via the fourth port 1040, which is in fluid communication with the outlet port 250. The fifth port 1050 is in a first closed position to prevent the fluid from flowing to the waste system.

As discussed herein, in some instances, the chemical feed line may be in fluid communication with the inlet port 240. Thus, during a chemical cleaning operation, the multi-port valve 1000 may be placed in the first valve configuration 1005. Therefore, the chemical cleaning agent 270 flows from the inlet port 240 into the multi-filter modular pack assembly 200 via the first port 1010 and into the plurality of filtration modules 310 via the second port 1020, which is in fluid communication with the first portion 330 of the manifold 322.

Further, a fluid pathway is formed between the third port 1030 and the fourth port 1040. Thus, the chemical cleaning agent 270 passes through the plurality of filtration modules 310 and is directed to the second portion 340 of the manifold 322, which is in fluid communication with the third port 1030. The chemical cleaning agent 270 is routed back to the aquatic application 100 via the fourth port 1040, which is in fluid communication with the outlet port 250. The fifth port 1050 is in a first closed position, depicted by a line pattern, blocking the chemical cleaning agent 270 from flowing to the waste system.

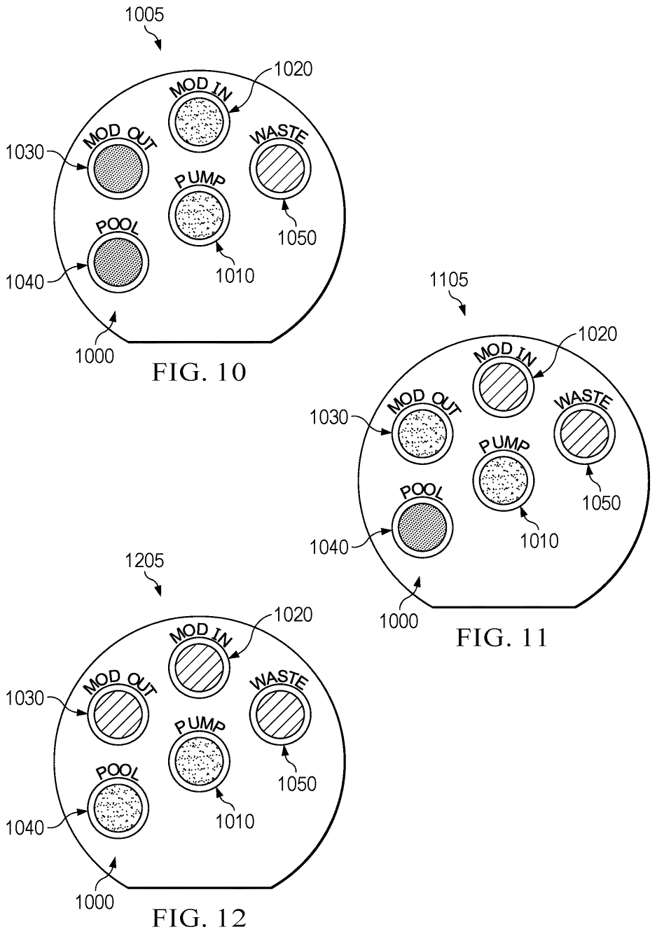

FIG. 11 is a schematic diagram showing a second valve configuration 1105 of the multi-port valve 1000 in a backwash mode and/or chemical cleaning mode. In the second valve configuration 1105, the first port 1010 and the third port 1030 are in a second open position, forming a fluid pathway between the first port 1010 and the third port 1030, depicted by a first stippling pattern. Fluid from the aquatic application 100 flows from the inlet port 240 into the multi-filter modular pack assembly 200 via the first port 1010 and into the plurality of filtration modules 310 via the third port 1030, entering the plurality of filtration modules 310 from the second portion 340 of the manifold 322 in a direction opposite to the filtration mode flow direction. Thus, during the backwash mode, the flow through the multi-filter modular pack assembly 200 is reversed as compared to the filtration mode, which may dislodge and remove accumulated particulates from the filtration media of the plurality of filtration modules 310, thereby helping to restore the permeability and filtering efficiency of the plurality of filtration modules 310.

Further, in the second valve configuration 1105, the second port 1020 is in a second open position, and the fifth port 1050 is in a first open position, forming a fluid pathway between the second port 1020 and the fifth port 1050, depicted by a line pattern. Thus, the backwash fluid, which carries the dislodged particulates removed from the plurality of filtration modules 310, flows out of the plurality of filtration modules 310 through the first portion 330 of the manifold 322, through the second port 1020, and to the waste system via the fifth port 1050. Accordingly, the fourth port 1040 is in a closed position, depicted by a second stippling pattern, preventing the incoming fluid and/or backwash fluid from flowing back to the aquatic application 100.

As discussed herein, in some instances, a chemical feed line 271 may be in fluid communication with the outlet port 250 (only a portion of the chemical feed line 271 is shown in FIG. 2). When the chemical feed line 271 is in fluid communication with the outlet port 250, the chemical cleaning agent 270 is introduced into the multi-filter modular pack assembly 200 downstream of the outlet port 250 and upstream of the third port 1030. The chemical cleaning agent 270 may be provided in the form of a variety of chemical cleaning agents and may be introduced into the plurality of filtration modules 310 to dissolve or remove accumulated foulants and help restore the permeability and filtering efficiency of the plurality of filtration modules 310. Thus, the second valve configuration 1105 may be utilized during a chemical cleaning operation. Accordingly, the chemical cleaning agent 270 is directed through the third port 1030 and to the plurality of filtration modules 310. The chemical cleaning agent 270 flows out of the plurality of filtration modules 310, through the first portion 330 of the manifold 322, through the first port 1010, and to the waste system via the fifth port 1050. The fourth port 1040 is in a closed position, blocking the chemical cleaning agent 270 from flowing back to the aquatic application 100.

FIG. 12 is a schematic diagram showing a third valve configuration 1205 of the multi-port valve 1000 in a bypass mode. In the third valve configuration 1205, the first port 1010 and the fourth port 1040 are in a third open configuration, depicted by a first stippling pattern. The second port 1020, the third port 1030, and the fifth port 1050 are in a closed position, depicted by a line pattern. Fluid from the aquatic application 100 flows from the inlet port 240 into the multi-filter modular pack assembly 200 via the first port 1010 and exits the multi-filter modular pack assembly 200 via the fourth port 1040. Thus, the fluid from the aquatic application 100 bypasses the plurality of filtration modules 310 and is returned to the aquatic application 100 without filtration, chemical treatment, or backwashing.

In some aspects, the one or more valves 350 (e.g., the first valve 351, the second valve 352, the third valve 353, and/or the multi-port valve 1000) are communicatively coupled to the central controller 150 of FIG. 1. Thus, the filtration, backwash, bypass, and chemical cleaning modes may be automated. The central controller 150 is designed to control the functions and operation of the multi-filter modular pack assembly 200 disclosed herein. The central controller 150 may work in conjunction with, or independent from, one or more local controllers associated with the one or more swimming pool components 102 disclosed herein, such as a pump controller, a heater controller, or a sanitization system controller. A benefit of automating the multi-filter modular pack assembly 200 is that the system is easier to operate and maintain, and cleaning procedures may be initiated automatically without user intervention. Accordingly, various methods for operating and cleaning the multi-filter modular pack assembly 200 are disclosed herein.

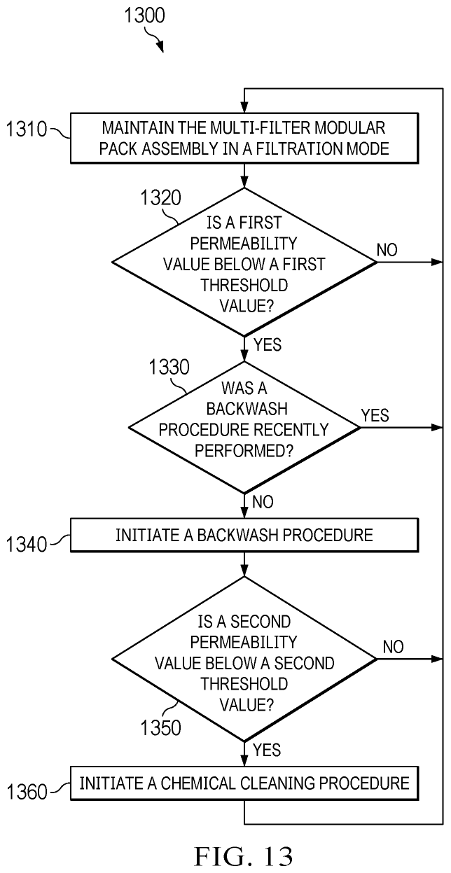

Turning to FIG. 13, a method 1300 for operating the multi-filter modular pack assembly 200 is illustrated. At a first step 1310, a system including the multi-filter modular pack assembly 200, such as the aquatic application 100 of FIG. 1, is operated in a filtration mode as described herein. During the filtration mode, water from the swimming pool 110 may flow through the multi-filter modular pack assembly 200 as described in FIGS. 7 and 10. Thus, the filtration mode may be the system's default or normal operational mode.

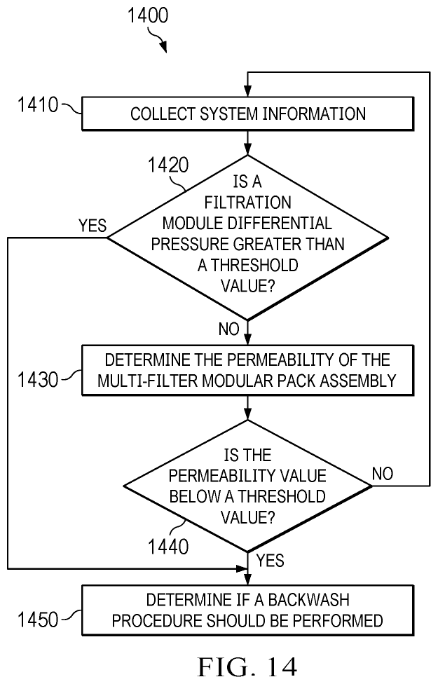

At step 1320, a controller, such as the central controller 150 of FIG. 1, may perform a first permeability check. A detailed discussion of the procedure for the permeability check is described with reference to FIG. 14. The permeability check may determine the permeability of the one or more filtration modules of the plurality of filtration modules 310 provided with the multi-filter modular pack assembly 200. Thus, the first permeability check may determine whether one or more filtration modules of the plurality of filtration modules 310 have become fouled and should be cleaned. The central controller 150 may be designed to perform the first permeability check at a predetermined time or interval of time. For instance, the central controller 150 may be designed to perform the first permeability check once an hour, once a day, once a week, etc. In some aspects, a user may manually prompt the central controller 150 to initiate the first permeability check.

The central controller 150 may be designed to analyze the results of the first permeability check to determine whether the multi-filter modular pack assembly 200 should be cleaned. In certain instances, the central controller 150 may determine whether particular filtration module(s) of the plurality of filtration modules 310 should be cleaned, or whether all of the filtration modules of the plurality of filtration modules 310 should be cleaned. In some instances, the central controller 150 may be designed to determine whether the first analyzed permeability value is above or below a first threshold permeability value. The first threshold permeability value may be a predetermined value for the system. In some instances, the first threshold permeability value may be set at a value of between about 150 to about 350 (or 150 to 350), although the first threshold permeability value may be less than or greater than these values. For example, the first threshold permeability may be imparted with a value of about 150, or about 200, or about 250, or about 300, or about 350. As an additional example, the first threshold permeability may be imparted with a value of 150, or 200, or 250, or 300, or 350. In other instances, the first threshold permeability value may be set at a value of approximately 300. In other examples, the first threshold permeability value may be set at a value of approximately 250. In still further instances, the first threshold permeability value may be set at a value of approximately 200.

If the analyzed first permeability value is above the first threshold permeability value, then the central controller 150 may maintain the multi-filter modular pack assembly 200 in the filtration mode. However, if the analyzed first permeability value is below the first threshold permeability value, then at step 1330, the controller may perform a check to determine if a backwash procedure was recently performed.

At step 1330, the central controller 150 may access a maintenance log or historical data of the multi-filter modular pack assembly 200 to determine when the last backwash procedure was performed. If the most recent backwash procedure was performed within the threshold time period, indicating that a backwash has been recently performed without sufficient restorative effect on permeability, the central controller 150 may be configured to bypass the backwash step and proceed directly to a chemical cleaning procedure. The threshold time period may be provided as a predetermined time period, such as one day, one week, etc. In some instances, the predetermined time period is 24 hours. However, if the previous backwash procedure was not performed within the threshold time period, the method may proceed to step 1340.

At step 1340, the central controller 150 may be designed to initiate a backwash procedure. During the backwash procedure, the water flow through the system may be reversed. Thus, water flow through the multi-filter modular pack assembly 200 may be reversed, as described above with reference to FIGS. 8 and 11, and with reference to FIG. 14 (discussed in more detail below). The backwash procedure may dislodge and remove accumulated particulates from the filtration media of the plurality of filtration modules 310, thereby helping to restore the permeability of the filtration media of the multi-filter modular pack assembly 200 toward its original permeability value.

Thus, at step 1350, the central controller 150 may be designed to perform a second permeability check after the backwash procedure is complete to determine the effectiveness of the backwash procedure. The central controller 150 may analyze the second permeability check to determine if the second analyzed permeability value is above or below a second threshold permeability value.

In some instances, the second threshold permeability value may be the same as the first threshold permeability value. In other instances, the second threshold permeability value may be different from the first threshold permeability value. For example, the second threshold permeability value may be set at a value greater than the first threshold permeability value because a backwash procedure may not fully restore the permeability of the multi-filter modular pack assembly 200 to its original, pre-fouling permeability value. However, it may not be necessary to perform additional cleaning procedures if the permeability is still below an upper threshold value. In still other instances, the second threshold permeability value may be equal to the upper threshold value. In some instances, the second threshold permeability value may be approximately 315. In further instances, the second threshold permeability value may be between about 250 and about 375, although the second threshold permeability value may be less than or even greater than these values. In other instances, the second threshold permeability value may be between about 300 and about 350. For example, the second threshold permeability may be imparted with a value of about 250, or about 275, or about 300, or about 325, or about 350, or about 375. As an additional example, the second threshold permeability value may be imparted with a value of 250, or 275, or 300, or 325, or 350, or 375.

If the second analyzed permeability value is at or above the second threshold permeability value, then the central controller 150 may maintain the multi-filter modular pack assembly 200 in the filtration mode, as the backwash procedure is determined to have sufficiently restored the permeability of the plurality of filtration modules 310. However, if the second analyzed permeability value remains below the second threshold permeability value following the backwash procedure, then at step 1360, the central controller 150 may initiate a chemical cleaning procedure. After the chemical cleaning procedure is completed, the multi-filter modular pack assembly 200 is ready to resume normal operation in the filtration mode.

Referring to FIG. 14, a method 1400 for performing a permeability check is illustrated in more detail. The method 1400 may be performed at steps 1320 and 1350 of the method 1300 of FIG. 13.

At step 1410, the central controller 150 may be designed to collect various details about the system in the form of system information. The system information may include one or more of a flow rate, an inlet pressure of the multi-filter modular pack assembly 200, an outlet pressure of the multi-filter modular pack assembly 200, an inlet pressure of one or more of the filtration modules of the plurality of filtration modules 310, and an outlet pressure of one or more filtration modules of the plurality of filtration modules 310, a temperature of the water passing through the system, or combinations thereof. Thus, the system may include one or more sensors designed to monitor these parameters (e.g., flowmeter, pressure transducer, temperature sensor, etc.).

At step 1420, the central controller 150 may determine the media differential pressure (i.e., the media headloss). The central controller 150 may determine the media headloss according to Formula I, described in further detail herein, using the inlet pressure and outlet pressure values collected at step 1410.

$$Media\_Headloss = Inlet\_Pressure - Module\_Pressure \qquad Formula I$$

Further, the module headloss may be determined according to Formula II.

$$Module\_Headloss = Module\_Pressure - Outlet\_Pressure \qquad Formula II$$

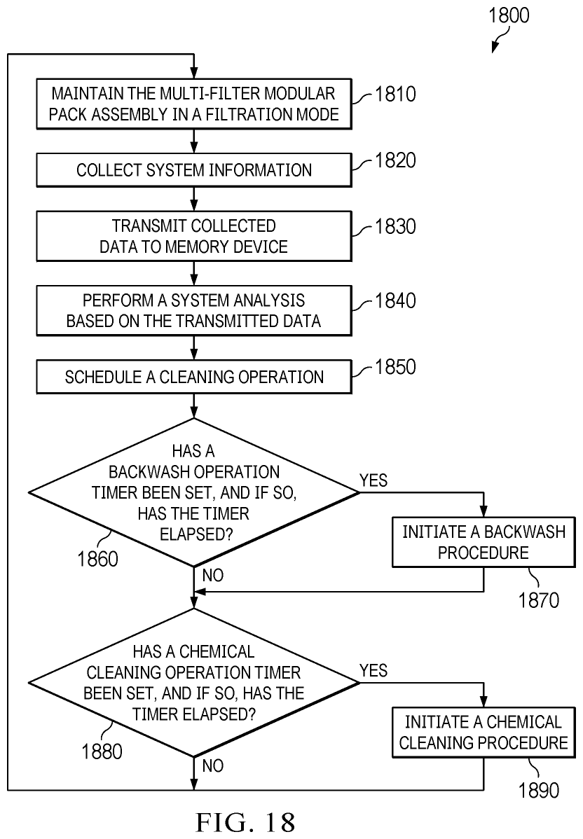

The central controller 150 may then determine if the media headloss is greater than or less than a media headloss threshold value. If the media headloss value is greater than the media headloss threshold value, then the method may proceed to step 1450 and determine if a backwash procedure should be performed (e.g., step 1870 of FIG. 18).

However, if the media headloss value is less than the media headloss threshold value, the method 1400 may proceed to step 1430. In some aspects, the media headloss threshold value is a predetermined value. For instance, the media headloss threshold value may be approximately 11 pounds per square inch (“PSI”). In other instances, the media headloss threshold value may be a value between about 4 PSI to about 20 PSI (or 4 PSI to 20 PSI), although the media headloss threshold value may be less than or even greater than these values. In further instances, the media headloss threshold value may be a value between about 8 PSI to about 15 PSI (or 8 PSI to 15 PSI). For example, the media headloss threshold may be imparted with a value of about 4 PSI, or about 6 PSI, or about 8 PSI, or about 10 PSI, or about 12 PSI, or about 14 PSI, or about 16 PSI, or about 18 PSI, or about 20 PSI. As an additional example, the media headloss threshold may be imparted with a value of 4 PSI, or 6 PSI, or 8 PSI, or 10 PSI, or 12 PSI, or 14 PSI, or 16 PSI, or 18 PSI, or 20 PSI. It is to be understood that the media headloss threshold may be imparted with a value greater or less than the value discussed herein.

At step 1430, the central controller 150 may be designed to determine the permeability of the multi-filter modular pack assembly 200.

As described herein, in some instances, one or more of the plurality of filtration modules 310 may be provided in the form of membrane filtration modules. The permeability of a membrane filtration module may be determined according to Formula III below.

$$System Permeability = ( ( Flux ) / ( ( TMP ) * 100000 ) * 100000 * ( Viscosity / 0.001 ) ) \qquad Formula III$$

The Flux may be defined by Formula IV.

$$Flux = ( System Flow ) * 227.125707 / ( membrane surface area ) \qquad Formula IV$$

TMP may represent the Transmembrane Pressure and be described by Formula V.

$$TMP = ( Filter Headloss ) * 0.06894757 \qquad Formula V$$

Wherein the Filter Headloss of Formula V may be determined by Formula VI.

$$Filter Headloss = Inlet Pressure - Outlet Pressure \qquad Formula VI$$

Referring back to Formula III, the viscosity may be calculated according to Formula VII.

$$Viscosity = ( ( 1.855 - 0.05596 * ( ( Water Temperature - 32 ) * 5 / 9 ) + 0.0006533 * ( ( Water Temperature - 32 ) * 5 / 9 ) \hat{} 2 ) / 0.99712 ) / 1000 \qquad Formula VII$$

Table 1 summarizes the units of measure for the parameters used in Formulas I-VII.

TABLE 1

| Parameter | Unit |
|---|---|
| Inlet Pressure | PSI |
| Outlet Pressure | PSI |
| Module Pressure | PSI |
| Filter Headloss | PSI |
| Module Headloss | PSI |
| Media Headloss | PSI |
| TMP | bar |
| System Flow | GPM (gallons per minute) |
| Flux | L/m²h (liters per square meter per hour) |
| Water Temp | Fahrenheit |
| Viscosity | N-s/m² (newton-second per square meter) |
| System Permeability | N/A |

As discussed above, each of the filtration modules of the plurality of filtration modules 310 may be provided in the form of other filter types (e.g., a diatomaceous earth filter, a pressure-fed sand filter, a gravity sand filter, a cartridge filter, an RO filter, and a SiC filter). Thus, other methods of determining permeability may be used. For example, permeability may be calculated using flow rate, pressure measurements, and the surface area of the filtration media while assuming the temperature and viscosity of the water (e.g., by using fixed or predetermined values for the temperature and viscosity of the water).

Still referring to FIG. 14, at step 1440, the central controller 150 may determine if the permeability of the multi-filter modular pack assembly 200 is above or below a permeability threshold value. The permeability threshold value may be the first permeability threshold value and/or the second permeability threshold value from the method 1300 of FIG. 13. Thus, if the permeability value is above the threshold permeability value, then the central controller 150 may maintain the system in a filtration mode and continue to monitor and collect the system information.

However, if the permeability is below the threshold permeability value, the central controller 150 may proceed to step 1450 and determine whether a backwash procedure should be performed based on the maintenance log of the multi-filter modular pack assembly 200 (e.g., consistent with step 1330 of FIG. 13 and/or step 1870 of FIG. 18). In some instances, the central controller 150 may be designed to confirm that the permeability of the multi-filter modular pack assembly 200 is below the threshold permeability value for a threshold time period. In various instances, the threshold time period may be about 5 seconds to about 120 seconds (or 5 seconds to 120 seconds), although the threshold time period may be less than or greater than these values. In some aspects, the threshold time period may be at least about 10 seconds. In other aspects, the threshold time period may be at least about 20 seconds. In yet another aspect, the threshold time period may be no more than about 60 seconds. In still further aspects, the threshold time period may be no more than about 30 seconds. For example, the threshold time period may be imparted with a value of about 5 seconds, or about 10 seconds, or about 20 seconds, or about 30 seconds, or about 40 seconds, or about 50 seconds, or about 60 seconds, or about 70 seconds, or about 80 seconds, or about 90 seconds, or about 100 seconds, or about 110 seconds, or about 120 seconds. As an additional example, the threshold time period may be imparted with a value of 5 seconds, or 10 seconds, or 20 seconds, or 30 seconds, or 40 seconds, or 50 seconds, or 60 seconds, or 70 seconds, or 80 seconds, or 90 seconds, or 100 seconds, or 110 seconds, or 120 seconds. In yet other aspects, the threshold time period may be set to a value less than or greater than the aforementioned values, for example, based on the sensitivity of the sensors used to monitor the system parameters or the specific requirements of the aquatic application 100.

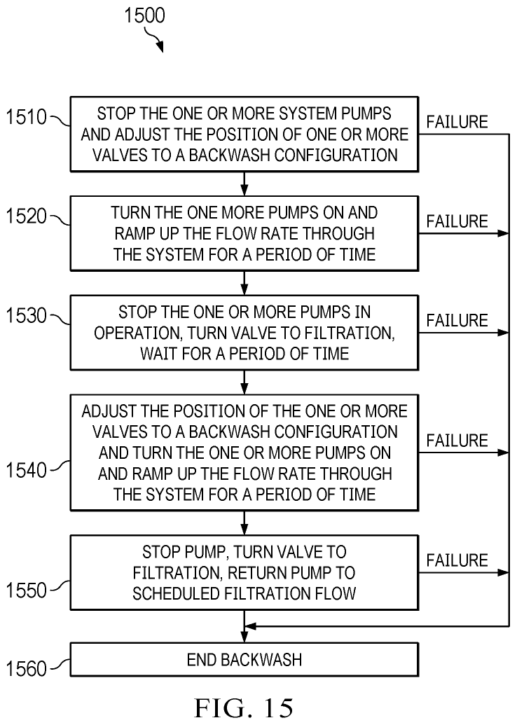

Turning to FIG. 15, a method 1500 for performing a backwash procedure is illustrated. The method 1500 may be performed at step 1340 and/or as part of the chemical cleaning procedure performed at step 1360 of the method 1300 of FIG. 13.

At step 1510, one or more pumps in fluid communication with the multi-filter modular pack assembly 200 (e.g., the variable speed pump 122 and/or the booster pump 123) are stopped so that fluid flow into and out of the multi-filter modular pack assembly 200 is stopped prior to repositioning the one or more valves 350. Further, the position of one or more valves 350 of the multi-filter modular pack assembly 200 may be oriented or configured so that the flow of the fluid through the multi-filter modular pack assembly 200 will be reversed when the fluid flow is re-established (e.g., the valve(s) of the multi-filter modular pack assembly 200 may be arranged in the second valve configuration 800 discussed with reference to FIG. 8 or the second valve configuration 1105 discussed with reference to FIG. 11). After the one or more valves 350 are adjusted to the backwash configuration, it may be beneficial to wait for a predetermined time period to allow the pressure within the multi-filter modular pack assembly 200 and associated conduit lines to equalize before resuming fluid flow. The predetermined time period may be imparted with a value of at least about 20 seconds to at least about 120 seconds (or at least 20 seconds to at least 120 seconds). For example, the predetermined time period may be imparted with a value of at least about 20 seconds, or at least about 40 seconds, or at least about 60 seconds, or at least about 80 seconds, or at least about 100 seconds, or at least about 120 seconds. As an additional example, the predetermined time period may be imparted with a value of at least 20 seconds, or at least 40 seconds, or at least 60 seconds, or at least 80 seconds, or at least 100 seconds, or at least 120 seconds. It is to be understood that the predetermined time period may be imparted with a value greater than or less than the maximum or minimum values described herein.

At step 1520, the one or more pumps may be turned back on, and the multi-filter modular pack assembly 200 may be backwashed. The fluid flow rate through the multi-filter modular pack assembly 200 may be increased to a desired backwash flow rate sufficient to dislodge accumulated particulates from the filtration media of the plurality of filtration modules 310. In some instances, the fluid flow rate may be increased to a flow rate of between about 50 GPM to about 90 GPM (or 50 GPM to 90 GPM), although the fluid flow rate may also be less than or even greater than these values. In other instances, the fluid flow rate may be increased to a flow rate of between about 65 GPM to about 75 GPM. In further instances, the fluid flow rate may be increased to a flow rate of about 70 GPM. For example, the fluid flow rate may be about 50 GPM, or about 55 GPM, or about 60 GPM, or about 65 GPM, or about 70 GPM, or about 75 GPM, or about 80 GPM, or about 85 GPM, or about 90 GPM. As an additional example, the fluid flow rate may be imparted with a value of 50 GPM, or 55 GPM, or 60 GPM, or 65 GPM, or 70 GPM, or 75 GPM, or 80 GPM, or 85 GPM, or 90 GPM. In some instances, the optimal backwash fluid flow rate may at least partially depend on the total membrane surface area of the plurality of filtration modules 310 within the multi-filter modular pack assembly 200, as well as the type of filtration media employed and the degree of fouling present.

The backwash may be maintained for a predetermined time period. For example, in some instances, the backwash is maintained for a predetermined time period of between about 10 seconds to about 60 seconds, although the predetermined time period may be less than or even greater than these values. In some instances, the predetermined time period may be imparted with a value between at least about 10 seconds to at least about 120 seconds. For example, the predetermined time period may be imparted with a value of at least about 10 seconds, or at least about 20 seconds, or at least about 40 seconds, or at least about 60 seconds, or at least about 80 seconds, or at least about 100 seconds, or at least about 120 seconds. As an additional example, the predetermined time period may be imparted with a value of at least 10 seconds, or at least 20 seconds, or at least 40 seconds, or at least 60 seconds, or at least 80 seconds, or at least 100 seconds, or at least 120 seconds. It is to be understood that the predetermined time period may be imparted with a value greater or lesser than the minimum and maximum values recited herein.

At step 1530, the one or more pumps may be stopped, and the one or more valves 350 may be adjusted back to the filtration mode orientation (e.g., the first valve configuration 700 discussed with reference to FIG. 7 or the first valve configuration 1005 discussed with reference to FIG. 10). At this point, a rinse operation may be performed to flush the contaminants dislodged from the plurality of filtration modules 310 during the backwash procedure from the conduit lines of the multi-filter modular pack assembly 200 and associated plumbing. In some instances, the rinse operation may be maintained for at least about 1 minute. In other instances, the rinse operation may be maintained for a period of time of at least about 30 seconds to at least about 3 minutes (or at least 30 seconds to at least 3 minutes). For example, the rinse operation may be maintained for at least about 30 seconds, or at least about 1 minute, or at least about 1.5 minutes, or at least about 2 minutes, or at least about 2.5 minutes, or at least about 3 minutes. As an additional example, the rinse operation may be maintained for at least 30 seconds, or at least 1 minute, or at least 1.5 minutes, or at least 2 minutes, or at least 2.5 minutes, or at least 3 minutes.

At step 1540, a second optional backwash may be performed. Thus, the one or more pumps may be stopped (if the one or more pumps are operating), and the one or more valves 350 may be adjusted to the backwash configuration (e.g., the second valve configuration 800 of FIG. 8 or the second valve configuration 1105 of FIG. 11), as described above with respect to step 1510. Then, similar to the first backwash described at step 1520, the one or more pumps may be turned on and the fluid flow rate may be increased to the desired backwash flow rate, which may be maintained for the predetermined time period described above.

At step 1550, the one or more pumps may be stopped, and the one or more valves 350 may be adjusted back to the filtration orientation. The one or more pumps may then be turned back on so that the multi-filter modular pack assembly 200 is operating in the filtration mode. Thus, the backwash method ends at 1560 and the multi-filter modular pack assembly 200 is returned to normal operation in the filtration mode.

As discussed above, one or more components of the system (e.g., the valves and the pumps) may be automated. Therefore, the central controller 150 may be designed to perform the above steps. However, if the central controller 150 fails to successfully complete any step of the backwash method 1500, the backwash procedure may be terminated and the multi-filter modular pack assembly 200 may be maintained in or returned to the filtration mode to preserve system operation and water quality. Additionally, in some instances, the above steps may be manually performed.

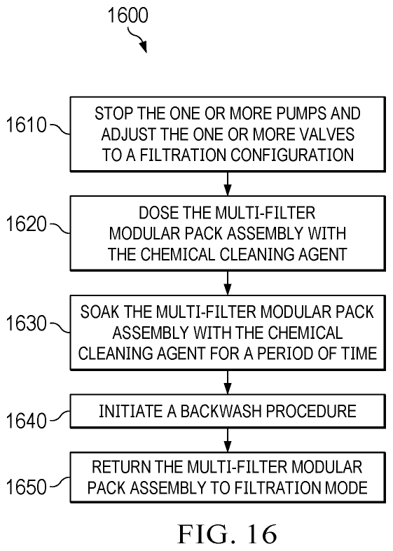

Now referring to FIG. 16, a method 1600 for chemically cleaning the multi-filter modular pack assembly 200 is illustrated. The method 1600 may be performed at step 1360 of the method 1300 of FIG. 13.

At step 1610, the one or more pumps of the system may be turned off or maintained in the off configuration. For example, in the method 1300 described in reference to FIG. 13, the chemical cleaning procedure may be performed after a backwash procedure. Thus, in some instances, the backwash procedure described with reference to FIG. 15 is performed as a preliminary step prior to the chemical cleaning procedure of the method 1600, in order to remove loosely accumulated particulates from the plurality of filtration modules 310 before introducing the chemical cleaning agent 270. Thus, after the backwash procedure is completed, the one or more pumps may already be turned off. Additionally, in some instances, one or more of the above steps may be manually performed by a user via the user device 160 or another user interface communicatively coupled to the central controller 150.

At step 1620, the chemical cleaning agent 270 may be introduced into the multi-filter modular pack assembly 200. As discussed herein, the multi-filter modular pack assembly 200 may include one or more valves, components (e.g., pumps), and/or feed lines that may control the flow of the chemical cleaning agent 270. Accordingly, depending on the instance, the one or more valves or components may need to be adjusted to permit the delivery of the chemical cleaning agent 270 to the multi-filter modular pack assembly 200. In some instances, the one or more valves or components of the multi-filter modular pack assembly 200 may be adjusted by the central controller 150. In other instances, the one or more valves or components of the multi-filter modular pack assembly 200 may be adjusted manually.

Further, the amount of the chemical cleaning agent 270 delivered to the multi-filter modular pack assembly 200 may depend on one or more of the size of the individual filtration modules of the plurality of filtration modules 310, the number of the one or more filtration modules 310 being cleaned, and/or the degree of fouling of the filtration modules 310 as determined by the permeability check described herein. In some instances, the multi-filter modular pack assembly 200 may be dosed with between at least about 50 milliliters of liquid chlorine to no more than about 450 milliliters of liquid chlorine, although the amount of liquid chlorine dosed to the multi-filter modular pack assembly 200 may be less than or even greater than these values. In further instances, the multi-filter modular pack assembly 200 may be dosed with between at least about 100 milliliters of liquid chlorine to at least about 400 milliliters of liquid chlorine. In some instances, the multi-filter modular pack assembly 200 may be dosed with at least about 320 milliliters of liquid chlorine. For example, the multi-filter modular pack assembly 200 may be dosed with at least about 50 milliliters, or at least about 75 milliliters, or at least about 100 milliliters, or at least about 125 milliliters, or at least about 150 milliliters, or at least about 175 milliliters, or at least about 200 milliliters, or at least about 250 milliliters, or at least about 300 milliliters, or at least about 350 milliliters, or at least about 400 milliliters, or at least about 450 milliliters of liquid chlorine. In an additional example, the multi-filter modular pack assembly 200 may be dosed with at least 50 milliliters, or at least 75 milliliters, or at least 100 milliliters, or at least 125 milliliters, or at least 150 milliliters, or at least 175 milliliters, or at least 200 milliliters, or at least 250 milliliters, or at least 300 milliliters, or at least 350 milliliters, or at least 400 milliliters, or at least 450 milliliters of liquid chlorine. In certain cases, the amount of chemical cleaning agent 270 dosed to the multi-filter modular pack assembly 200 may be at least about 50 milliliters of liquid chlorine per filter that is cleaned. The chemical cleaning agent 270 may be provided in other forms or in other volumes greater or less than those discussed herein.

At step 1630, the flow of the chemical cleaning agent 270 to the multi-filter modular pack assembly 200 may be stopped, and one or more components of the multi-filter modular pack assembly 200 (e.g., the plurality of filtration modules 310) may be soaked with the chemical cleaning agent 270 for a predetermined time period. A benefit of soaking the plurality of filtration modules 310 with the chemical cleaning agent 270 is that the extended contact time allows the chemical cleaning agent 270 to dissolve, neutralize, and/or dislodge accumulated foulants from the filtration media of the plurality of filtration modules 310. In some instances, the multi-filter modular pack assembly 200 may be soaked between about 1 hour to about 5 hours, although the multi-filter modular pack assembly 200 may be soaked for a shorter or greater amount of time. In some instances, the multi-filter modular pack assembly 200 may be soaked between about 2 hours to about 4 hours. In some aspects, the multi-filter modular pack assembly 200 may be soaked for about 3 hours. For example, the multi-filter modular pack assembly 200 may be soaked for at least about 1 hour, or at least about 2 hours, or at least about 3 hours, or at least about 4 hours, or at least about 5 hours. As an additional example, the multi-filter modular pack assembly 200 may be soaked for at least 1 hour, or at least 2 hours, or at least 3 hours, or at least 4 hours, or at least 5 hours.

At step 1640, a backwash procedure may be initiated after the multi-filter modular pack assembly 200 has been soaked. The backwash procedure may be performed according to the method 1500 of FIG. 15. A benefit of backwashing the multi-filter modular pack assembly 200 after the chemical cleaning procedure is that the chemical cleaning agent 270 and the associated contaminants may be flushed from the system.

Thus, at step 1650, after the backwash procedure is completed, the multi-filter modular pack assembly 200 may be returned to the filtration mode.

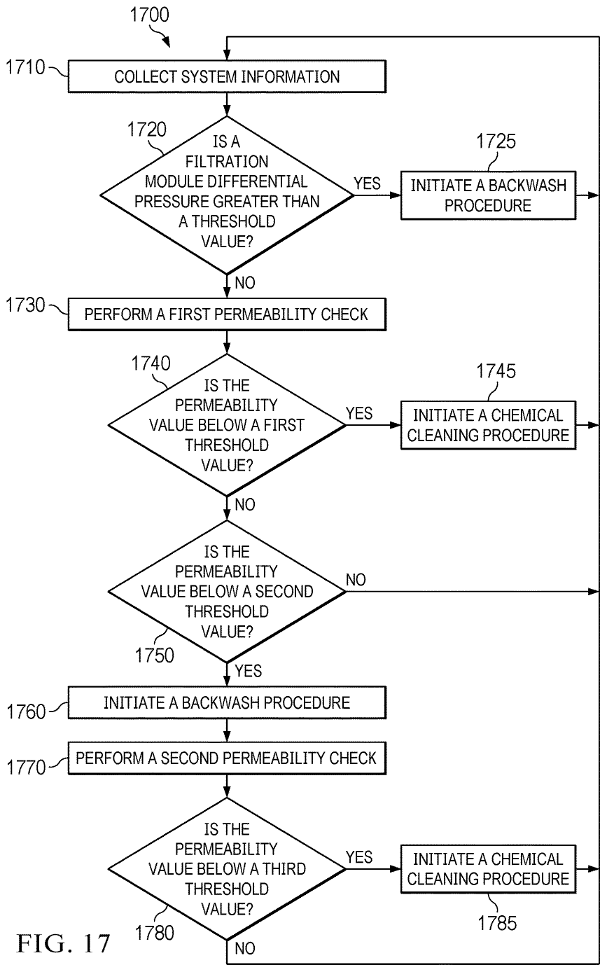

Now referring to FIG. 17, an alternative method 1700 for operating the multi-filter modular pack assembly 200 is illustrated. The method 1700 is similar to the method 1300 of FIG. 13 in that it uses permeability-based decision logic to determine whether a backwash and/or chemical cleaning procedure is required. However, the method 1700 differs from the method 1300 in that it includes an additional media headloss check at step 1720 prior to the permeability check and employs three permeability threshold values rather than two.

At a first step 1710, the central controller 150 may be designed to collect various details about the multi-filter modular pack assembly 200 in the form of system information. The system information may include one or more of a flow rate, an inlet pressure of the multi-filter modular pack assembly 200, an outlet pressure of the multi-filter modular pack assembly 200, one or more inlet pressures from the plurality of filtration modules 310, one or more outlet pressures from the plurality of filtration modules 310, a temperature of the water passing through the system, or combinations thereof. Thus, the multi-filter modular pack assembly 200 may include one or more sensors configured to monitor these parameters, such as one or more flowmeters, pressure transducers, and/or temperature sensors, communicatively coupled to the central controller 150.

At step 1720, the central controller 150 may determine the media differential pressure (i.e., the media headloss). In some implementations, the media differential pressure may be determined according to Formula I above. The central controller 150 may then determine if the media headloss is greater than or less than a media headloss threshold value. If the media headloss value is greater than the media headloss threshold value, indicating that the pressure drop across the filtration media is excessive and that the plurality of filtration modules 310 are likely fouled with accumulated particulates, then the method may proceed to step 1725 and initiate a backwash procedure. The backwash procedure may be performed according to the method 1500 of FIG. 15. Once the backwash procedure is completed, the method may return to step 1710, and the central controller 150 may continue to monitor the system.

However, if the media headloss value is at or below the media headloss threshold value, indicating that pressure drop across the filtration media is within an acceptable range, the method may proceed to step 1730 to perform a permeability check. In some instances, the media headloss threshold value is a predetermined value. For instance, the media headloss threshold value may be approximately 11 PSI. In other instances, the media headloss threshold value may be a value between about 4 PSI to about 20 PSI, although the media headloss threshold value may be less than or even greater than these values. In further instances, the media headloss threshold value may be a value between about 8 PSI to about 15 PSI. For example, the media headloss threshold value may be a value of at least about 4 PSI, or at least about 8 PSI, or at least about 12 PSI, or at least about 16 PSI, or at least about 20 PSI. As an additional example, the media headloss threshold value may be a value of at least 4 PSI, or at least 8 PSI, or at least 12 PSI, or at least 16 PSI, or at least 20 PSI.

At step 1730, the central controller 150 may be designed to determine the permeability of the multi-filter modular pack assembly 200 during a first permeability check operation. In some instances, the permeability of the multi-filter modular pack assembly 200 may be determined according to Formula III above.

At step 1740, the central controller 150 may determine if the permeability of the multi-filter modular pack assembly 200 is above or below a first permeability threshold value. The first permeability threshold value may be a predetermined value for the system. In some aspects, the first permeability threshold value is a minimum permeability value. In some instances, the first permeability threshold value may be set at a value of between at least about 75 to no more than about 225 (or at least 75 to no more than 225), although the first permeability threshold value may be less than or even greater than these values. For example, the permeability threshold value may be imparted with a value of at least about 75, or at least about 100, or at least about 125, or at least about 150, or at least about 175, or at least about 200, or no more than about 225. As an additional example, the permeability threshold value may be imparted with a value of at least 75, or at least 100, or at least 125, or at least 150, or at least 175, or at least 200, or no more than 225. It is to be understood that the first permeability threshold value may be imparted with a value greater or less than the minimums and maximums described herein and may be imparted with a value between any of the ranges recited herein.

If the analyzed first permeability value is below the first permeability threshold value, then the central controller 150 may be designed to initiate a chemical cleaning procedure at step 1745. In some instances, step 1745 may be performed immediately or shortly after step 1740. A benefit of proceeding directly to a chemical cleaning procedure when the first permeability value is below the first permeability threshold value may be that the degree of fouling is sufficiently severe that a backwash procedure alone would be unlikely to adequately restore the permeability of the plurality of filtration modules 310, and therefore the chemical cleaning procedure may be more effective and efficient.

However, if the analyzed first permeability value is above the first permeability threshold value, then at step 1750, the central controller 150 may further determine if the analyzed first permeability value is above or below a second permeability threshold value. The second permeability threshold value may be a predetermined value for the system. In some instances, the second permeability threshold value may be set to a value greater than the first permeability threshold value. For example, the second permeability threshold value may be set to a value of between about 150 to about 350, although the second permeability threshold value may be less than or even greater than these values. In other instances, the second permeability threshold value may be set at a value of approximately 300. In other examples, the second permeability threshold value may be set at a value of approximately 250. In still further instances, the second permeability threshold value may be set at a value of approximately 200.

If the analyzed first permeability value is above the second permeability threshold value, then the central controller 150 may maintain the multi-filter modular pack assembly 200 in the filtration mode and continue to monitor the system. However, if the analyzed first permeability value is below the second permeability threshold value, then at step 1760, the central controller 150 may initiate a backwash procedure.

At step 1760, the backwash procedure may be performed according to the method 1500 of FIG. 15.

Then, at step 1770, the central controller 150 may be designed to perform a second permeability check to determine how effective the backwash procedure was. Similar to the first permeability check, the second permeability of the multi-filter modular pack assembly 200 may be determined according to Formula III above.

At step 1780, the central controller 150 may analyze the second permeability check to determine if the second analyzed permeability value is above or below a third permeability threshold value. In some instances, the third permeability threshold value may be the same as the second permeability threshold value. In other instances, the third permeability threshold value may be different from the second permeability threshold value. For example, the third permeability threshold value may be greater than the second permeability threshold value because a backwash procedure may not fully restore the permeability of the multi-filter modular pack assembly 200 to its original, pre-fouling permeability value. However, it may not be necessary to perform additional cleaning procedures if the permeability of the multi-filter modular pack assembly 200, while not fully restored, remains above a minimum acceptable threshold value. However, it may not be necessary to perform additional cleaning procedures if the multi-filter modular pack assembly's 200 permeability is still below an upper threshold value. In some instances, the third permeability threshold value may be equal to an upper threshold value. In some aspects, the third permeability threshold value may be at least about 315. In other aspects, the third permeability threshold value may be a range of at least about 250 to at least about 375, although the third permeability threshold value may be less than or even greater than these values. For example, the third permeability threshold value may be at least about 250, or at least about 275, or at least about 300, or at least about 325, or at least about 350, or at least about 375. As an additional example, the third permeability threshold value may be at least 250, or at least 275, or at least 300, or at least 325, or at least 350, or at least 375.

However, if the analyzed second permeability value is below the third permeability threshold value at step 1780, the central controller 150 may be designed to initiate a chemical cleaning procedure (i.e., a step 1785). In some instances, the chemical cleaning procedure step 1785 may be performed immediately or shortly after step 1780. In other instances, the chemical cleaning procedure step 1785 may be delayed. It may be beneficial to delay a cleaning procedure, such as the backwash and/or chemical cleaning procedure, because it may not be ideal or safe for swimmers to use the swimming pool 110 while the multi-filter modular pack assembly 200 is undergoing a chemical cleaning procedure, particularly given the introduction of the chemical cleaning agent 270 into the system. Thus, the following description discusses methods for delaying (i.e., scheduling) one or more cleaning procedures.

Turning to FIG. 18, a method 1800 for scheduling backwash and chemical cleaning operations is illustrated. The method 1800 may be used in conjunction with the methods 1300-1700 of FIGS. 13-17.

At a first step 1810, the multi-filter modular pack assembly 200 is operated in a filtration mode. As discussed above, during the filtration mode, water from the swimming pool 110 may flow through the multi-filter modular pack assembly 200 as described in FIGS. 7 and 10. Thus, the filtration mode may be the default or normal operational mode for the system.

At step 1820, the central controller 150 may be designed to collect various details about the system in the form of system information. Similar to step 1410, in the step 1820 the system information may include one or more of a flow rate, an inlet pressure of the multi-filter modular pack assembly 200, an outlet pressure of the multi-filter modular pack assembly 200, a plurality of filtration module inlet pressures, a plurality of filtration module outlet pressures, a temperature of the water passing through the system, or combinations thereof. Thus, the system may include one or more sensors designed to monitor these parameters (e.g., flowmeter, pressure transducer, temperature sensor, etc.).

At step 1830, the central controller 150 may transmit the collected data to a memory device. Referring back to FIG. 1, the memory device may be communicatively coupled to the central controller 150 directly or via the cloud network 170, and may be configured to store historical system data for use in the system analysis at step 1840.

At step 1840, the central controller 150 may be designed to perform a system analysis based on the transmitted data. The system analysis may include at least one of a permeability check, a check to determine when the most recent backwash procedure was performed, a check to determine when the most recent chemical cleaning procedure was performed, an analysis to determine a filtration module differential pressure (e.g., a media headloss), and any other analysis of a system operational parameter such as a flow rate, an inlet pressure of the multi-filter modular pack assembly 200, an outlet pressure of the multi-filter modular pack assembly 200, one or more inlet pressures of the plurality of filtration modules 310, one or more outlet pressures of the plurality of filtration modules 310, a temperature of the fluid passing through the system.

The transmitted data may include historical data. Thus, in some instances, the system analysis may be based on current data. In other instances, the system analysis may be performed on historical data. Further, in some instances, the system analysis may be based on both current and historical data. Utilizing both current and historical data may be beneficial because not all system parameters may be monitored at the same frequency, and relying on historical data may allow the central controller 150 to perform a meaningful system analysis even when one or more current sensor readings are unavailable or have not yet been updated. In some instances, the central controller 150 may be configured to weight recent data more heavily than older historical data when performing the system analysis. However, it may be desirable to perform a system analysis without having to collect updated information.

At step 1850, the central controller 150 may schedule a cleaning operation based on the analyzed system data. In some instances, the cleaning operation may be scheduled to be initiated immediately or in the near future. For example, it may be beneficial to perform a cleaning operation immediately if the system analysis determines that the permeability of the multi-filter modular pack assembly 200 is below a minimum permeability threshold value. In other instances, the cleaning operation may be scheduled for a later time period. It may be desirable to delay a cleaning operation if the aquatic application 100 is currently in use. Thus, in some instances, the cleaning operation may be delayed by a set time period (e.g., one hour, four hours, etc.). In some instances, the cleaning operation may be delayed until a predetermined time of day (e.g., nighttime or early morning) when the aquatic application 100 is not typically in use by swimmers. In some instances, the predetermined time may be programmed by a user via the user device 160 or may be determined automatically by the central controller 150 based on historical usage patterns of the aquatic application 100. A benefit of scheduling the cleaning operation for a time when the aquatic application 100 is unlikely to be in use is that the cleaning operation may not interrupt swimmers from enjoying the aquatic application 100. The cleaning operation may include at least one of a backwash operation and a chemical cleaning operation. Thus, the below steps illustrate a portion of a scheduling operation.

At step 1860, the central controller 150 may determine if a backwash operation timer has been set. In some instances, the central controller 150 may automatically set the backwash operation timer. For example, following a backwash procedure, the central controller 150 may start a backwash operation timer to indicate when a subsequent backwash procedure may need to be performed. Thus, the backwash timer may be set for a specific time period so that a backwash cleaning operation is performed on a routine basis. In some instances, the backwash operation time period may be manually selected by a user and input into the aquatic application 100 via the user device 160 or another user interface. In other instances, the central controller 150 may determine an optimal backwash operation time period based on the analyzed system data, including historical fouling patterns of the plurality of filtration modules 310. For instance, the analyzed historical data may indicate that the multi-filter modular pack assembly 200 tends to experience accelerated fouling during periods of high aquatic application usage (e.g., weekends or holidays), and the central controller 150 may therefore schedule a backwash procedure in advance of such anticipated high-usage periods. For instance, the analyzed data may show that the multi-filter modular pack assembly 200 tends to experience the most fouling over weekends. Therefore, the central controller 150 may determine an optimal time period to clean the multi-filter modular pack assembly 200 before, during, and/or after the weekend.

The central controller 150 may further determine whether the backwash operation timer has elapsed. If the backwash operation timer has elapsed, then at step 1870, the central controller 150 may initiate a backwash procedure. The backwash procedure may be performed according to the method 1500 described with reference to FIG. 15, including, in some instances, the optional second backwash at step 1540. Once the backwash procedure is completed, the method may proceed to step 1880 to determine if a chemical cleaning operation timer has been set. However, if the backwash operation timer has not elapsed, then the method may proceed directly to step 1880.

At step 1880, the central controller 150 may determine if a chemical cleaning operation timer has been set. Similar to the backwash operation timer, the chemical cleaning timer may be set by the user or the central controller 150. If the chemical cleaning operation timer has elapsed, then at step 1890, the central controller 150 may initiate a chemical cleaning procedure. The chemical cleaning procedure may be performed according to the method 1600 of FIG. 16. Once the chemical cleaning procedure is completed, the central controller may return the system to a filtration mode. However, if the chemical cleaning operation timer has not elapsed, then the central controller 150 may return the system to the filtration mode after the backwash procedure is completed.

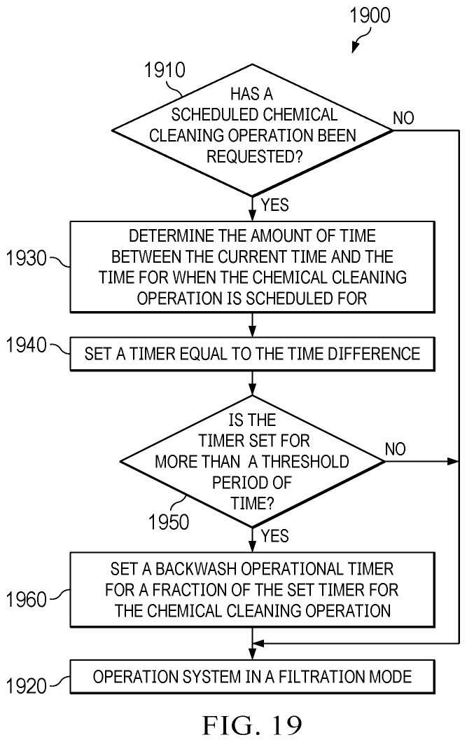

Turning to FIG. 19, another method 1900 for scheduling a backwash cleaning operation and/or a chemical cleaning operation is illustrated. The method 1900 may be used in conjunction with the methods 1300-1800 of FIGS. 13-18.

At step 1910, the central controller 150 may determine if a scheduled cleaning operation has been requested. If the central controller 150 determines that no request for a chemical cleaning procedure has been made, then the central controller 150 may maintain or return the system to the filtration mode at step 1920. However, if the central controller 150 determines that a request for a chemical cleaning procedure has been made, then the central controller 150 may proceed to step 1930. Thus, the method 1900 may be initiated after a cleaning operation has been scheduled. Therefore, although not shown, the method 1900 may include steps 1810-1850 of the method 1800 of FIG. 18. In some instances, the method 1900 may be performed at step 1850 of method 1800 of FIG. 18 (e.g., to schedule the timer).

At step 1930, the central controller 150 may determine the amount of time between the current time and the time when the scheduled chemical cleaning operation has been requested. In some instances, the central controller 150 may determine when the chemical cleaning operation is scheduled by analyzing data stored in the memory, which is communicatively coupled to the central controller 150.

At step 1940, the central controller 150 may set a timer approximately equal to the time difference determined at step 1930.

Then, at step 1950, the central controller 150 may determine if the set timer is more than or less than a threshold time period. The threshold time period may be a predetermined time period. In some instances, the threshold time period is about one day. In other instances, the threshold time period is approximately half a day. In other examples, the predetermined time period is at least about 10 hours. In still further instances, the predetermined time period may be set to at least about 8 hours. In some instances, the threshold time period may be less than or even greater than the aforementioned values. In some instances, the threshold time period may be set by a user and input into the aquatic application 100 via the user device 160 or another user interface. In some aspects, the central controller 150 may determine an optimal threshold time period based on system information, as discussed above.

If the set timer is less than the threshold time period, then the central controller 150 may be designed to maintain or return the multi-filter modular pack assembly 200 to the filtration mode and await expiration of the set timer, at which point the scheduled cleaning operation will be automatically initiated. However, if the set timer is greater than the threshold time period, then at step 1960, the central controller 150 may set a backwash operational timer.

At step 1960, the central controller 150 may set the backwash operational timer for a timer period that is a fraction of (i.e., less than) the time set for the chemical cleaning operation. In some instances, the backwash operational timer is set for approximately half the time as the chemical cleaning operational timer. In other instances, the backwash operational timer is set for approximately one-third of the time as the chemical cleaning operational timer. For example, the backwash operational time may be imparted with a value that is at least about one-half, or at least about one-third, or at least about one-fifth, or at least about one-sixth, or at least about one-seventh of the chemical cleaning operational time. As an additional example, the backwash operational timer may be imparted with a value that is at least one-half, or at least one-third, or at least one-fourth, or at least one-fifth, or at least one-sixth, or at least one-seventh of the chemical cleaning operational timer. Thus, a backwash operational procedure may be automatically performed prior to the chemical cleaning procedure, so that loosely accumulated particulates are removed from the plurality of filtration modules 310 before the chemical cleaning agent 270 is introduced, thereby improving the effectiveness of the chemical cleaning procedure. In some instances, the central controller 150 may be designed to maintain or return the system to the filtration mode until the backwash operational timer elapses and the system is transitioned to the backwash operational mode, because the backwash operational procedure may not be scheduled to be immediately performed.

It is to be understood that the above methods may be implemented in any of the systems (e.g., the aquatic application 100, the multi-filter modular pack assembly 200, and variations thereof) described herein. Accordingly, the methods 1300-1900 may include more or fewer steps depending on the instance. In addition, the methods 1300-1900 may be implemented more than once, and the steps of the methods 1300-1900 may be performed in any order. In some cases, one or more steps of the methods 1300-1900 may be omitted.

The methods 1300-1900, and various parameters of the aquatic application 100 and multi-filter modular pack assembly 200, have been described with reference to various numerical parameters, threshold values, predetermined ranges of values, and the like. It is to be understood that the described parameters may be imparted with discrete values, or ranges of values, falling within any minimum and maximum value or range detailed herein.

Further, as discussed above, the central controller 150 may be designed to perform the above methods. Referring back to FIG. 1, the central controller 150 may receive data from one or more of the components of the aquatic application 100, analyze the data as discussed herein, and execute one or more of the methods described above. Thus, the central controller 150 may create a communication link that operatively connects the plurality of the system components. Accordingly, the central controller 150 may include one or more of a receiver, a memory, a processor, and a transmitter.

The receiver may be designed to receive transmitted data from the aquatic application 100. For example, as discussed above, the aquatic application 100 may include one or more of a flowmeter, a pressure transducer, a temperature sensor, and the like to monitor various system operational parameters. Thus, the receiver may receive the transmitted data from the one or more sensors. In some instances, the receiver may receive data inputs from a user. For example, a user may input a preferred schedule for a cleaning operation.

The memory may be designed to store system information received from the one or more system components and/or user inputs. In some instances, the memory may be integrated with one or more of the system components discussed herein. In other instances, the memory may be implemented as a stand-alone memory unit.

The processor may be a programmable processor communicatively coupled to the memory. In some instances, the programmable processor may include program instructions that are stored on a cloud server, a non-transitory computer-readable medium, and that are executable by the programmable processor to perform one or more of the methods described herein.

The transmitter may be designed to send the instructions from the processor to the one or more system components. Thus, the above methods may be automated.

Further, in some instances, one or more of the above methods may use machine learning (ML), artificial intelligence (AI), or similar technologies to iteratively train the central controller and improve the performance of the system based on one or more feedback parameters, characteristics, or similar. For example, in some instances, ML/AI may be used to predict an optimal cleaning schedule based on system data such as filter loading data, bather load data, geographic location of the system, weather data, user preferences, and the like. In some instances, ML/AI may be used to provide accurate chemical dosing and/or predict chemical usage trends. Thus, the system may be optimized to reduce fluctuations in the chemical dosage. This may be beneficial because it may reduce the likelihood of high chemical concentrations in the pool water, which may irritate bathers. Additionally, it may help a user determine how much chemicals are needed for the system and/or when to reorder chemicals.

It will be appreciated by those skilled in the art that while the above disclosure has been described above in connection with particular instances and examples, the above disclosure is not necessarily so limited and that numerous other instances, examples, uses, modifications, and departures from the instances, examples, and uses are intended to be encompassed by the claims attached hereto. The entire disclosure of each patent and publication cited herein is incorporated by reference as if each such patent or publication were individually incorporated by reference herein. The following claims set forth various features and advantages of the above disclosure.

What is claimed is:

1. A multi-filter modular pack assembly for filtering a fluid from an aquatic application, comprising:
a vessel including:
a housing;
a plurality of filtration modules contained within the housing designed to filter the fluid from the aquatic application and produce a filtered fluid;
an inlet port designed to direct the fluid from the aquatic application into the vessel; and
an outlet port designed to direct the filtered fluid out of the vessel to the aquatic application; and
one or more valves designed to control a flow of fluid, wherein the one or more valves are in fluid communication with at least one of the inlet port, the outlet port, or the plurality of filtration modules.

2. The multi-filter modular pack assembly of claim 1, wherein each filtration module of the plurality of filtration modules is independently selected from the group consisting of a diatomaceous earth filter, a pressure-fed sand filter, a gravity sand filter, a cartridge filter, a reverse osmosis filter, a hollow fiber membrane filter, and a silicon carbide filter.

3. The multi-filter modular pack assembly of claim 1, wherein the plurality of filtration modules includes four filtration modules.

4. The multi-filter modular pack assembly of claim 1, wherein the one or more valves include at least one isolation valve that is disposed within the vessel and is in fluid communication with the plurality of filtration modules, wherein the at least one isolation valve is designed to control whether fluid is provided to a filtration module of the one or more of the plurality of filtration modules.

5. The multi-filter modular pack assembly of claim 1, wherein the plurality of filtration modules are configured to process fluid in parallel.

6. The multi-filter modular pack assembly of claim 5 further comprising a fluid distribution system including a manifold designed to secure the plurality of filtration modules in a vertical configuration, the fluid distribution system including:
a first manifold including a plurality of filtration module inlets designed to direct the fluid from the aquatic application into the plurality of filtration modules; and
a second manifold including a plurality of filtration module outlets designed to direct the filtered fluid from the plurality of filtration modules to the outlet port of the vessel.

7. The multi-filter modular pack assembly of claim 1, wherein a valve of the one or more valves is provided as a three-way valve and wherein the valve is placed in fluid communication with a filtration module of the plurality of filtration modules, the inlet port, and the outlet port.

8. The multi-filter modular pack assembly of claim 1, wherein a valve of the one or more valves is provided as a multi-port valve, and the valve is placed in fluid communication with at least one filtration module of the plurality of filtration modules, the inlet port, and the outlet port.

9. A multi-filter modular pack assembly for filtering fluid from an aquatic application, comprising:
a vessel including a plurality of filtration modules;
an inlet conduit designed to direct an untreated fluid or a pre-filtered fluid from the aquatic application to the plurality of filtration modules;
an outlet conduit designed to direct a filtered fluid from the multi-filter modular pack assembly to the aquatic application;
a chemical cleaning system including a chemical cleaning tank designed to retain a chemical cleaning agent, wherein the chemical cleaning system is in fluid communication with the vessel; and
a controller designed to:
determine whether one or more of the plurality of filtration modules is fouled based on a determined permeability value; and
initiate a cleaning procedure when the determined permeability value is below a permeability threshold value.

10. The multi-filter modular pack assembly of claim 9, wherein the chemical cleaning agent is selected from the group consisting of chlorine, bromine, calcium hypochlorite, trichloroisocyanuric acid, dichloro-s-triazinetrione, and combinations thereof.

11. The multi-filter modular pack assembly of claim 9, wherein:
the cleaning procedure includes a backwash procedure,
wherein the multi-filter modular pack assembly is imparted with a first permeability before the backwash procedure,
the backwash procedure imparts the multi-filter modular pack assembly with a second permeability,
the second permeability is greater than the first permeability.

12. The multi-filter modular pack assembly of claim 9, wherein the cleaning procedure includes a chemical cleaning procedure, wherein the chemical cleaning procedure includes introducing the chemical cleaning agent to one or more of the plurality of filtration modules.

13. The multi-filter modular pack assembly of claim 9, wherein the chemical cleaning system includes a chemical feed line in fluid communication with the inlet conduit.

14. The multi-filter modular pack assembly of claim 9, wherein the chemical cleaning system includes a chemical feed line in fluid communication with a dosing port designed to deliver the chemical cleaning agent to the plurality of filtration modules.

15. The multi-filter modular pack assembly of claim 9, wherein the determined permeability value is associated with a measured permeability for one or more of the plurality of filtration modules.

16. The multi-filter modular pack assembly of claim 9, wherein the plurality of filtration modules include an air bleed designed to release a volume of air trapped in the plurality of filtration modules.

17. A method for cleaning a multi-filter modular pack assembly comprising:
receiving an untreated or pre-filtered fluid from an aquatic application into a multi-filter modular pack assembly;
directing the untreated or pre-filtered fluid into one or more of a plurality of filtration modules;
determining a pressure differential between an inlet of the multi-filter modular pack assembly and an outlet of the multi-filter modular pack assembly;
determining whether the pressure differential exceeds a predetermined pressure differential threshold value; and
initiating a cleaning procedure when the pressure differential exceeds a predetermined pressure differential threshold value.

18. The method of claim 17 further comprising:
determining a permeability of the multi-filter modular pack assembly;
comparing the permeability of the multi-filter modular pack assembly to a predetermined permeability value; and
determining if the permeability of the multi-filter modular pack assembly exceeds the predetermined permeability value.

19. The method of claim 17 further comprising:
setting a start time for the cleaning procedure; and
waiting a predetermined time period.

20. The method of claim 17 further comprising:
determining a measured period of time between a first cleaning procedure and a second cleaning procedure before the second cleaning procedure has been initiated;
determining whether the measured period of time exceeds a predetermined threshold time period; and
preventing initiation of the second cleaning procedure until the measured period of time exceeds the predetermined threshold time period.
